(19) United States
(12) Patent Application Publication
(10) Pub. No.: US 2016/0182963 A1
(43) Pub. Date: Jun. 23, 2016

(54) SENTV TABLET UX

(71) Applicants: SONY CORPORATION, Tokyo (JP); SONY NETWORK ENTERTAINMENT INTERNATIONAL LLC, Los Angeles, CA (US)

(72) Inventor: Jim Unwin, San Francisco, CA (US)

(21) Appl. No.: 14/581,793

(22) Filed: Dec. 23, 2014

(51) Int. Cl. H04N 21/482; H04N 21/2187; H04N 21/478; H04N 21/81; H04N 21/472; H04N 21/475

(52) U.S. Cl. CPC H04N 21/482; H04N 21/47202; H04N 21/4751; H04N 21/478; H04N 21/8133; H04N 21/2187

(57) ABSTRACT

An interactive television enables a user to experience television in an interactive manner by personalizing the content and allowing the user to modify selections with ease.

### FIELD OF THE INVENTION

The present invention relates to the user interfaces. More specifically, the present invention relates to personalized user interfaces.

### BACKGROUND OF THE INVENTION

Cable companies provide user interfaces that enables a user to view channel and content information; however, these user interfaces have several shortcomings.

### SUMMARY OF THE INVENTION

SENTV combines the personalization of video-on-demand streaming with and the immediacy of live broadcast to give a viewer a unique television viewing experience.

In one aspect, a method programmed in a non-transitory memory of a device comprises displaying content and displaying a graphical user interface configured to receive user input to affect the content, wherein the graphical user interface includes a standalone mode and a companion mode. The content includes live broadcast content and on-demand content. The content includes extended information including news articles, web log posts, and additional information related to the content. The content includes extended information provided by a network including behind-the-scenes footage, interviews and clips. The content includes extended information including images of a character/actor from a show and character/actor information. The graphical user interface enables a user to add a profile to an account. The profile is selected from a previously-generated network profile. The graphical user interface is configured to pop up when an input is received from a second device. The standalone mode involves a single device, and the companion mode involves the device and a second device such that the device displays the content, and the second device displays the graphical user interface. The graphical user interface is configured in a portrait mode to fit a second device with a smaller screen than the first device. The device is selected from the group consisting of a personal computer, a laptop computer, a computer workstation, a server, a mainframe computer, a handheld computer, a personal digital assistant, a cellular/mobile telephone, a smart phone, a smart appliance, a gaming console, a digital camera, a digital camcorder, a camera phone, an portable music player, a tablet computer, a video player, a DVD writer/player, a high definition video writer/player, a television and a home entertainment system.

In another aspect, a system comprises a first device for displaying content and a second device operatively coupled to the first device, the second device configured for displaying a graphical user interface configured to receive user input to affect the content, wherein the graphical user interface includes a standalone mode and a companion mode. The content includes live broadcast content and on-demand content. The content includes extended information including news articles, web log posts, and additional information related to the content. The content includes extended information provided by a network including behind-the-scenes footage, interviews and clips. The content includes extended information including images of a character/actor from a show and character/actor information. The graphical user interface enables a user to add a profile to an account. The profile is selected from a previously-generated network profile. The graphical user interface is configured to pop up when an input is received from a second device. The standalone mode involves a single device, and the companion mode involves the device and a second device such that the device displays the content, and the second device displays the graphical user interface. The graphical user interface is configured in a portrait mode to fit a second device with a smaller screen than the first device.

In another aspect, an apparatus comprises a non-transitory memory for storing an application, the application for: displaying content and displaying a graphical user interface configured to receive user input to affect the content, wherein the graphical user interface includes a standalone mode and a companion mode and a processing component coupled to the memory, the processing component configured for processing the application. The content includes live broadcast content and on-demand content. The content includes extended information including news articles, web log posts, and additional information related to the content. The content includes extended information provided by a network including behind-the-scenes footage, interviews and clips. The content includes extended information including images of a character/actor from a show and character/actor information. The graphical user interface enables a user to add a profile to an account. The profile is selected from a previously-generated network profile. The graphical user interface is configured to pop up when an input is received from a second device. The standalone mode involves a single device, and the companion mode involves the device and a second device such that the device displays the content, and the second device displays the graphical user interface. The graphical user interface is configured in a portrait mode to fit a second device with a smaller screen than the first device.

### BRIEF DESCRIPTION OF THE DRAWINGS

FIG. 1 illustrates a navigation stack diagram according to some embodiments.

FIG. 2 illustrates a diagram of screen types and the navigation stack according to some embodiments.

FIG. 3 illustrates a diagram of program selection according to some embodiments.

FIG. 4 illustrates series popup features according to some embodiments.

FIG. 5 illustrates advanced video control according to some embodiments.

FIG. 6 illustrates a diagram of companion viewing according to some embodiments.

FIG. 7 illustrates exemplary menu states according to some embodiments.

FIG. 8 illustrates a diagram of launching SENTV for the first time according to some embodiments.

FIG. 9 illustrates a diagram of signing up for trial mode according to some embodiments.

FIG. 10 illustrates a diagram of signing into trial or subscriber modes according to some embodiments.

FIG. 11 illustrates a diagram of favorites displayed in a swipable grid according to some embodiments.

FIG. 12 illustrates a diagram of categories according to some embodiments.

FIG. 13 illustrates a diagram of an exemplary home screen according to some embodiments.

FIG. 14 illustrates a diagram of portrait mode according to some embodiments.

FIG. 15 illustrates a diagram of an exemplary television guide according to some embodiments.

FIG. 16 illustrates an exemplary television guide in portrait mode according to some embodiments.

FIG. 17 illustrates an exemplary search screen according to some embodiments.

FIG. 18 illustrates an exemplary browse screen according to some embodiments.

FIG. 19 illustrates an exemplary browse screen with filter bar down according to some embodiments.

FIG. 20 illustrates diagrams of collections according to some embodiments.

FIG. 21 illustrates a standard collection with hero according to some embodiments.

FIG. 22 illustrates an exemplary television show detail according to some embodiments.

FIG. 23 illustrates an exemplary syndicated television show pop-up according to some embodiments.

FIG. 24 illustrates an exemplary special television show pop-up according to some embodiments.

FIG. 25 illustrates an exemplary news pop-up according to some embodiments.

FIG. 26 illustrates an exemplary movie pop-up according to some embodiments.

FIG. 27 illustrates a diagram of viewing multiple program details according to some embodiments.

FIGS. 28-32 illustrate exemplary screenshots of extended information according to some embodiments.

FIG. 33 illustrates an exemplary screenshot of a standard companion mode according to some embodiments.

FIG. 34 illustrates an exemplary screenshot of an extended information companion mode according to some embodiments.

FIG. 35 illustrates an exemplary screenshot of a user selecting to send the video to another device according to some embodiments.

FIG. 36 illustrates an exemplary screenshot of a quick menu according to some embodiments.

FIG. 37 illustrates a diagram of adding a profile according to some embodiments.

FIG. 38 illustrates a flowchart of a method of implementing the interactive television method according to some embodiments.

FIG. 39 illustrates a block diagram of an exemplary computing device configured to implement the interactive television method according to some embodiments.

### DETAILED DESCRIPTION OF THE PREFERRED EMBODIMENT

Sony Entertainment Network TV (SENTV) includes many features such as a navigation, menu, product modes, categories, search, browse, collection detail, program detail and extended information, video, settings, tiles and hero banners.

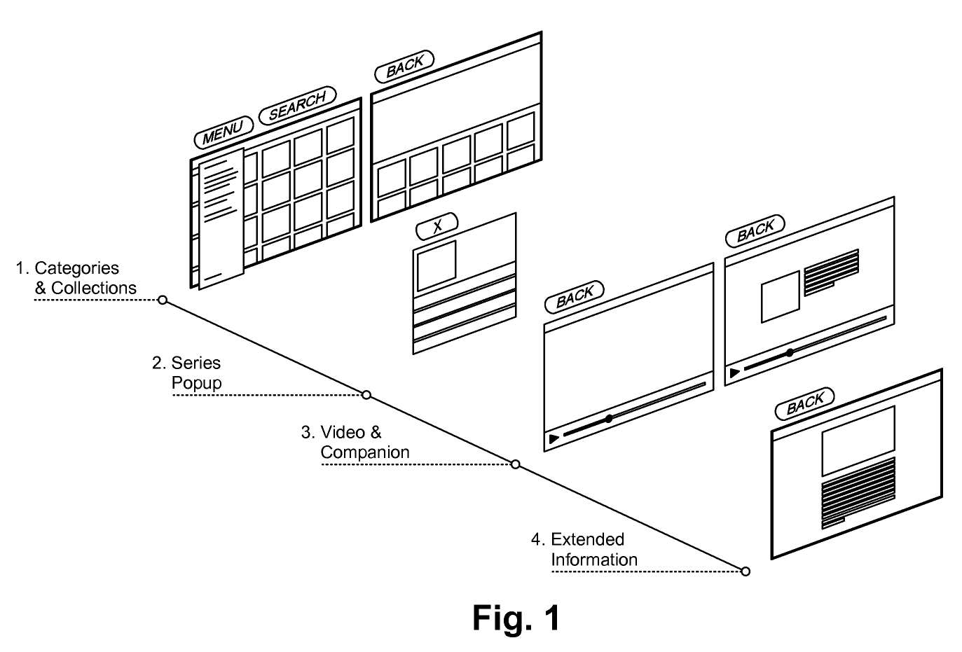

FIG. 1 illustrates a navigation stack diagram according to some embodiments. The stack includes categories and collections, series popup, video and companion, and extended information.

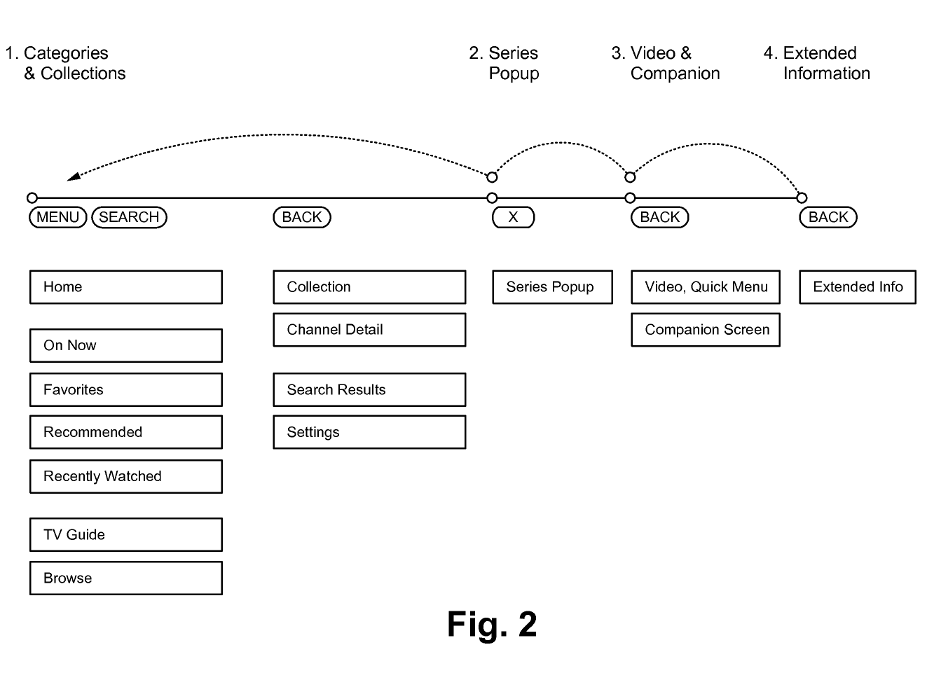

FIG. 2 illustrates a diagram of screen types and the navigation stack according to some embodiments.

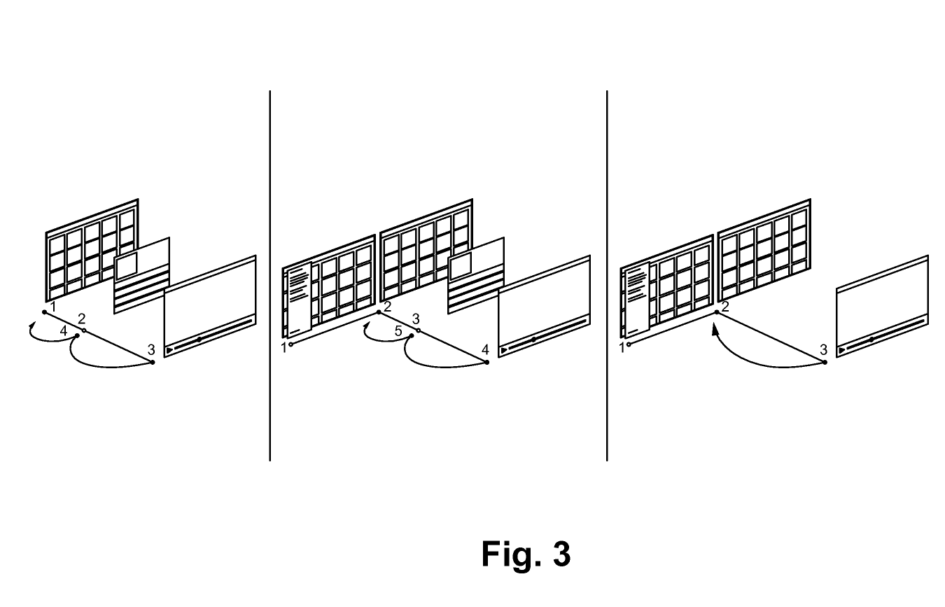

FIG. 3 illustrates a diagram of program selection according to some embodiments. For Basic Program Selection: 1. Tap a tile to open the series popup. 2. Tap an episode to open the video player. 3. Tap “Back” to exit the video and return to the popup. 4. Tap “X” to close the popup. To Change Categories, then Select a Program: 1. Open the menu and tap a category to change screens. 2. Tap a tile to open the series popup. 3. Tap an episode to open the video player. 4. Tap “Back” to exit the video and return to the popup. 5. Tap “X” to close the popup. For Playing Programs from the TV Guide: 1. Open the menu and tap TV Guide to change screens. 2. Tap the play button to open the video player. 3. Tap “Back” to return to the TV Guide.

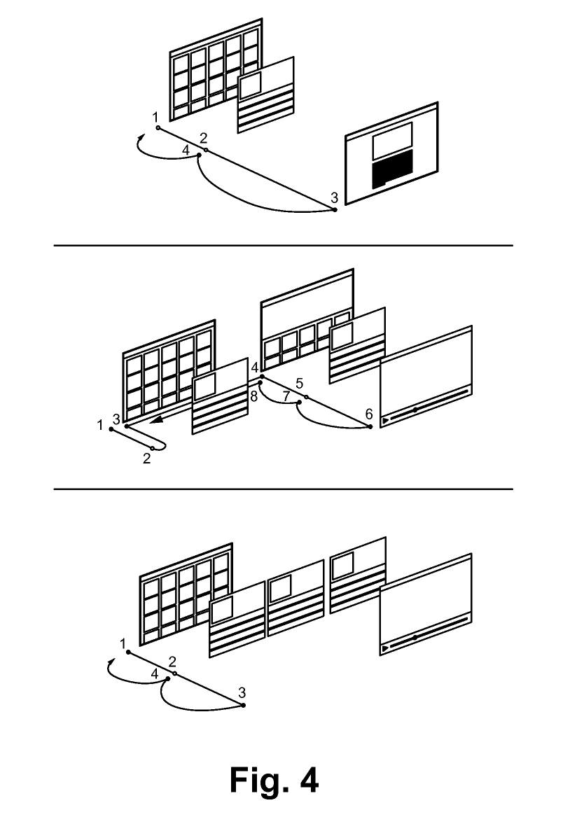

FIG. 4 illustrates series popup features according to some embodiments. To open Extended Information from the Series Popup: 1. Tap a tile to open the series popup. 2. Scroll down to the Extended Information section. Tap an article, photo or video to open the Extended Info viewer. 3. Tap “Back” to return to the series popup. 4. Tap “X” to close the popup. For pivoting on Metadata: 1. Tap a tile to open the series popup. 2. Tap a piece of meta data (e.g., “Horror”) to open a dynamic collection based on the that metadata. 3. The user is taken to the first UI layer before moving to the dynamic collection. 4. Tap a tile to open the series popup. 5. Tap an episode to open the video player. 6. Tap “Back” to exit the video and return to the popup. 7. Tap “X” to close the popup and return to the collection. 8. Tap “Back” to leave the collection and return to the previous category page. For Cross-Navigating through Series Popup Recommendations: 1. Tap a tile to open the series popup. 2. Tap a recommendation at the bottom of the series popup to open a new, adjacent popup. Tap an episode to open the video player. 3. Tap “Back” to return to the series popup. The popup breadcrumb is saved. 4. Tap “X” to close the popup.

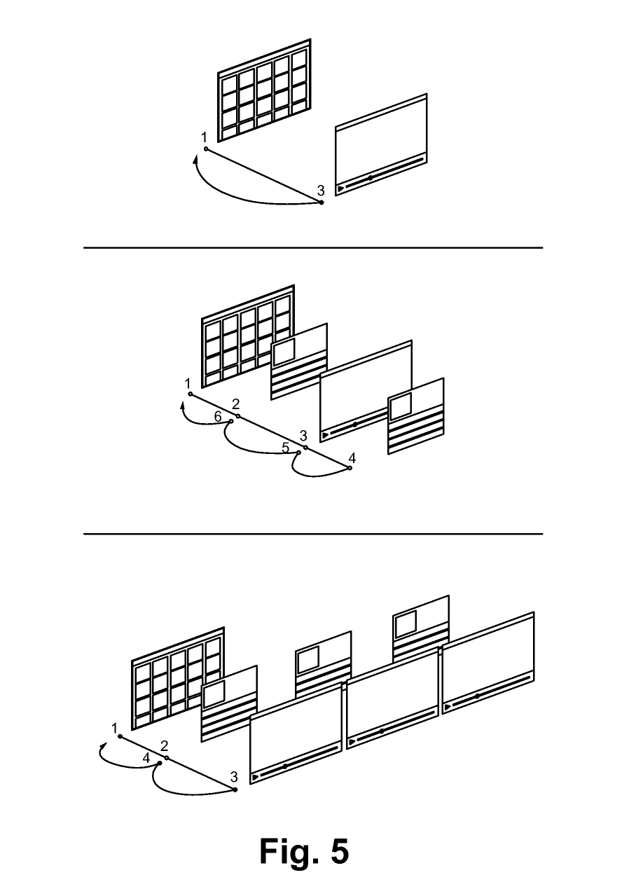

FIG. 5 illustrates advanced video control according to some embodiments. To Quickly Access a Program: 1. Some tiles, like those in the On Now section of the Home page, allow the user to immediately play a show without opening the series popup. Tap the Play button to open the video player and start playback. 2. Tap “Back” to return to the category screen. To change Episodes While Watching a Video 1. Tap a tile to open the series popup. 2. Tap an episode to open the video player. 3. Tap the series name in the title bar to open the series popup for the currently-playing video. 4. Tap a different episode to return to the video player. 5. Tap “Back” to exit the video and return to the popup. 6. Tap “X” to close the popup. To watch Many Videos in a Row: 1. Tap a tile to open the series popup. 2. Tap an episode to open the video player. 3. When the video ends, the next video will automatically load. The user can also open the quick menu and manually select a new video. Tap “Back” to return to the series popup. 4. When the user leaves the video, he will land on the series popup for the video he just watched. Additionally, the videos he watched have generated a popup breadcrumb.

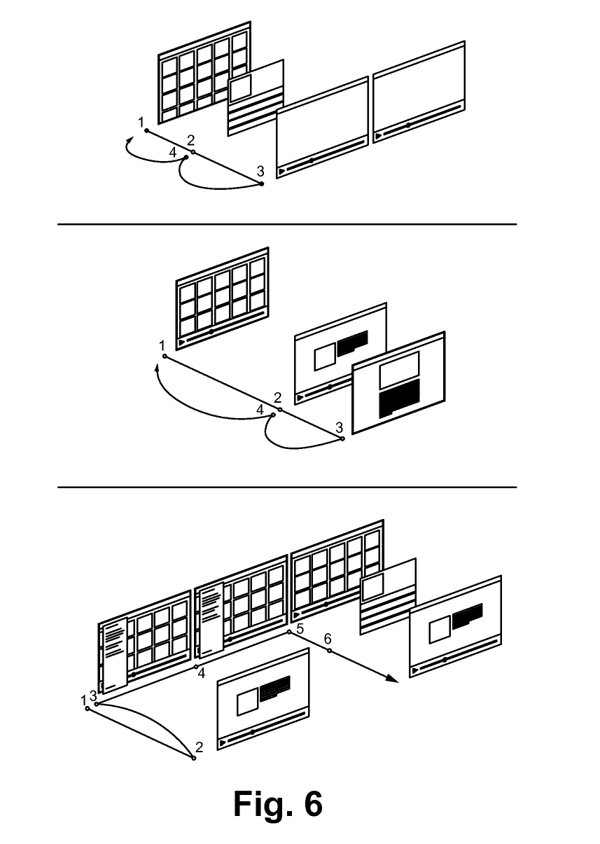

FIG. 6 illustrates a diagram of companion viewing according to some embodiments. To Send Video to the Television: 1. Tap a tile to open the series popup. 2. Tap an episode to open the video player. 3. While watching a video, the user is able to tap the “Send to TV” button to toggle from standalone video mode to companion mode. The video screen becomes the companion screen. Tapping “Back” leaves the companion screen but the video continues playing on the TV. 4. Tap “X” to close the popup. To Quickly Jump to the Video Currently Playing on the TV, Explore Extended Information: 1. When the user is browsing categories while watching a video in companion mode, playback controls are present at the bottom of the screen. The playback controls persist until the user exits companion mode. Tap the playback bar to jump immediately to the currently-playing video. 2. If the series has Extended Information, the user can tap an article or photo to open the Extended Information viewer while the video continues playing on the TV. 3. Tap “Back” to return to the companion screen. 4. Tap “Back” to return to the category screen. The video continues playing on the TV after leaving the companion screen. To Browse Videos While in Companion Mode: 1. Use the persistent playback bar to jump to the companion screen. 2. Tap “Back” to return to the category screen. 3. When the user is browsing categories while watching a video in companion mode, playback controls are present at the bottom of the screen. The playback controls persist until the user exits companion mode. Open the menu and select another category. 4. Open the menu and select another category. 5. Tap a tile to open the series popup. 6. Tap an episode to open the video player. 7. When the user selects a new video, it replaces the video playing on the TV, and the user is taken to the companion screen.

The menu is able to be opened on any category screen. The menu allows the user to jump to any of the primary category screens: Home, On Now, Favorites, Recommended, Recently Watched, TV Guide, Browse or Settings.

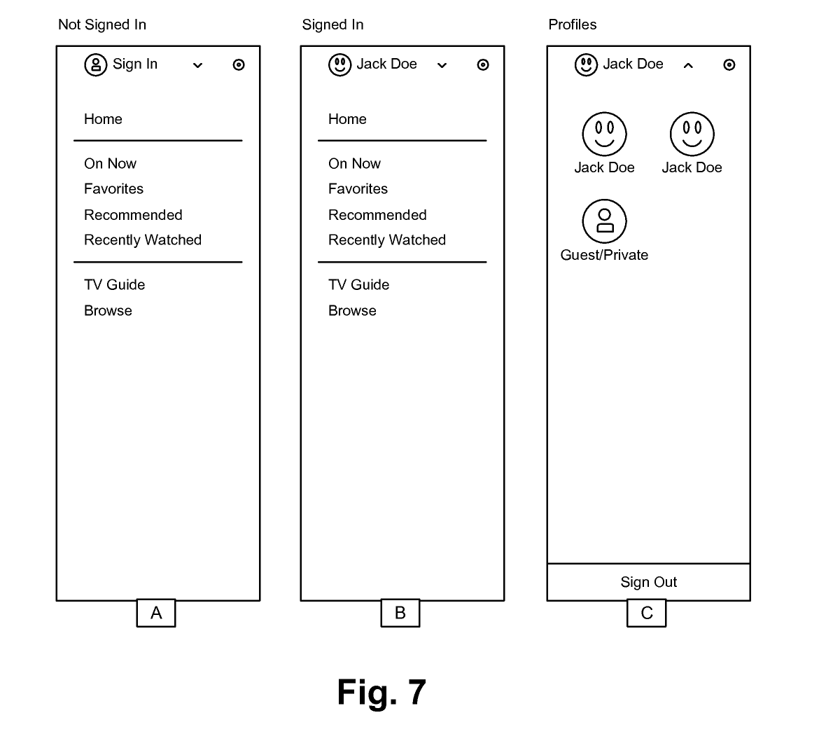

FIG. 7 illustrates exemplary menu states according to some embodiments. The menu has 3 states: not signed in, signed in, and profiles. Not Signed In—If the user is not signed in, the menu will display a sign in button at the top of the menu. Signed In—If the user is signed in, the menu will display their username at the top of the menu. Profiles—Selecting the username will display a profiles dropdown. The user can switch users or sign out of SENTV.

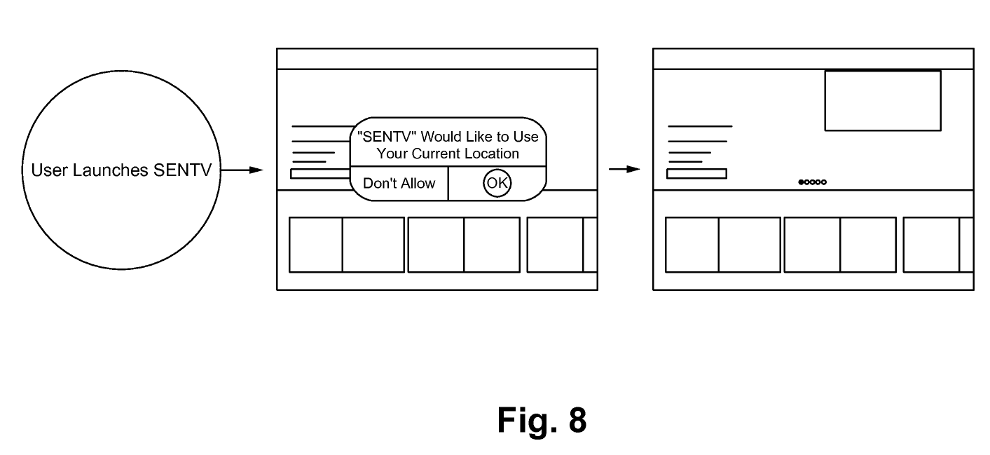

There are three product modes in SENTV: Intro mode, Trial mode and Subscriber mode. FIG. 8 illustrates a diagram of launching SENTV for the first time according to some embodiments. When a user launches SENTV for the first time, the user is asked to allow location tracking. By selecting “OK,” the application is populated with location appropriate content. If the user selects “Don't Allow,” he will see limited intro mode content.

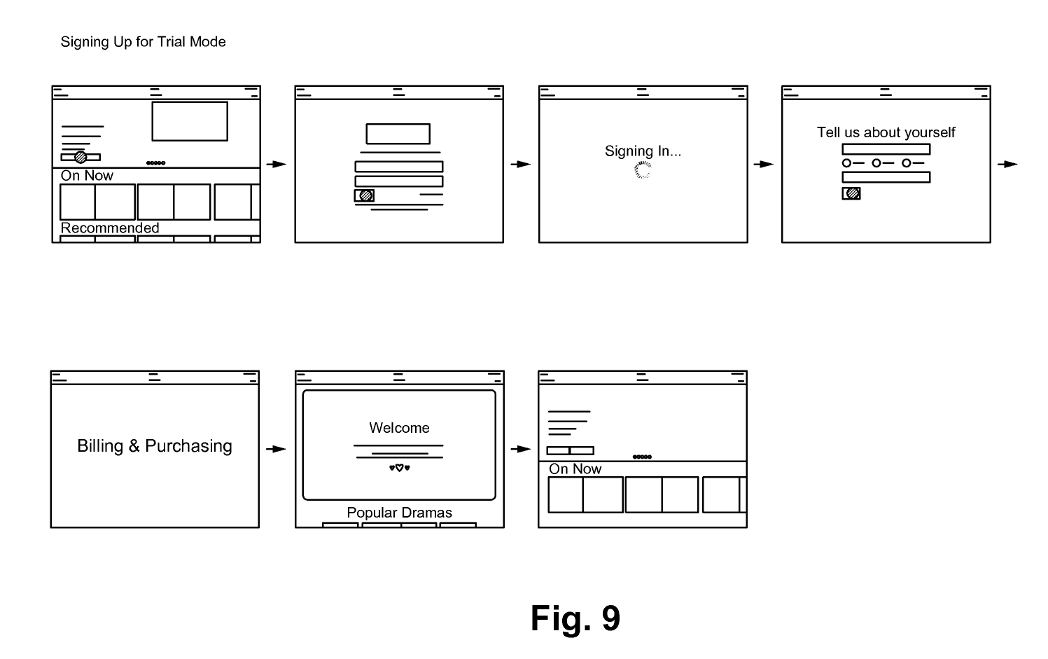

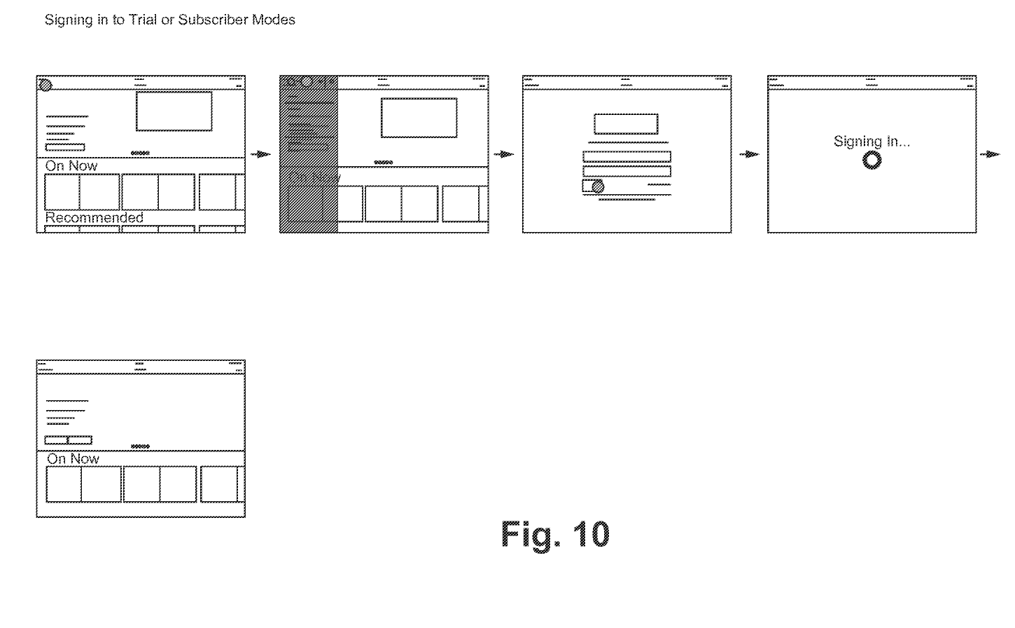

FIG. 9 illustrates a diagram of signing up for trial mode according to some embodiments. FIG. 10 illustrates a diagram of signing into trial or subscriber modes according to some embodiments.

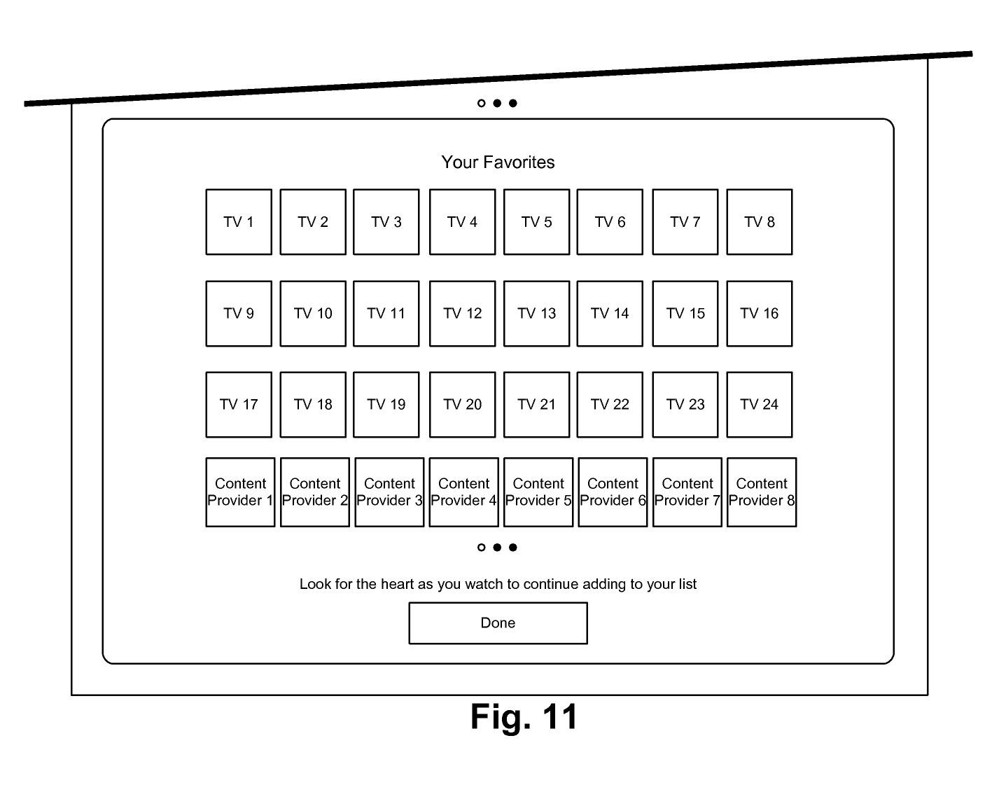

The first time user experience educates the user about the importance of adding favorites and other aspects. Users are able to select favorite items such as shows, genres and channels. FIG. 11 illustrates a diagram of favorites displayed in a swipable grid according to some embodiments.

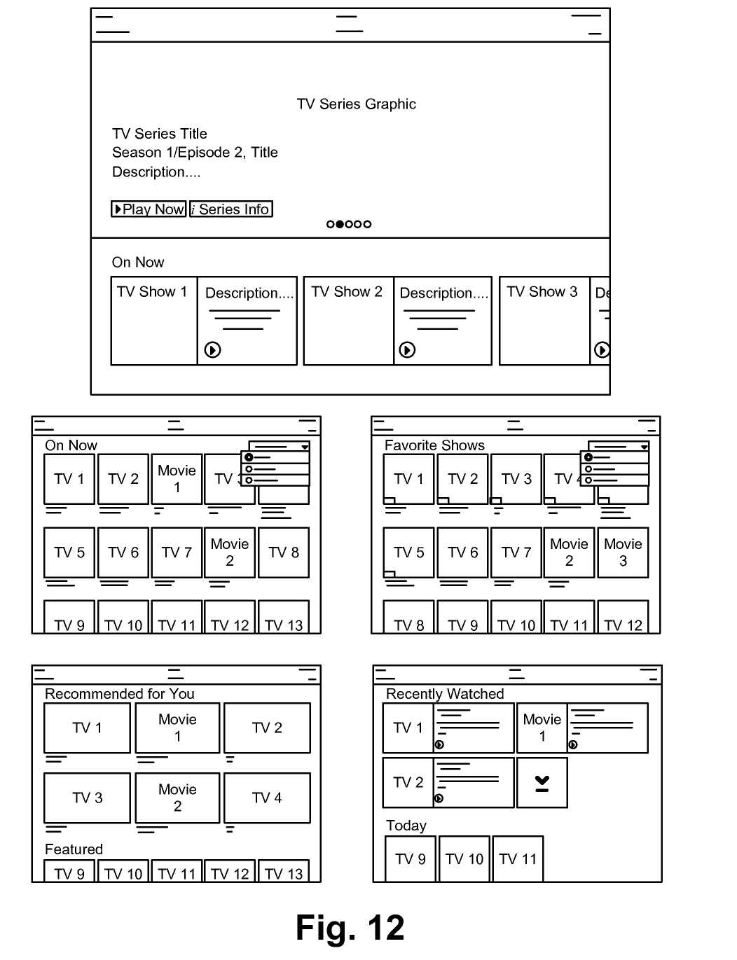

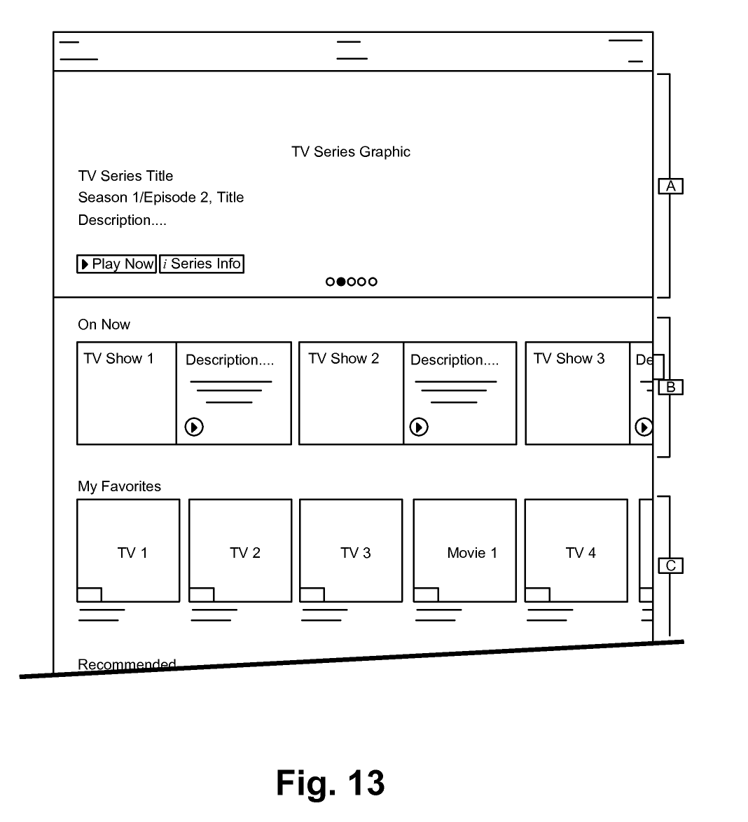

Information is able to be categorized in categories such as home, on now, favorites, recommended and recently watched. FIG. 12 illustrates a diagram of categories according to some embodiments. FIG. 13 illustrates a diagram of an exemplary home screen according to some embodiments. Each category has a horizontally-scrollable row. The rows are able to be swiped by users to view more content.

Any of the content is able to be filtered by trending, program A-Z, channel A-Z or any other filtering. The content is able to be presented as a wall of tiles. Content is able to be recommended based on the user's activity, featured shows and collections and what is most popular on SENTV.

Recently watched programs are able to be displayed. Programs that the user did not finish watching are stored, and the user is able to resume watching a program by selecting it. Previously watched programs are also able to be displayed.

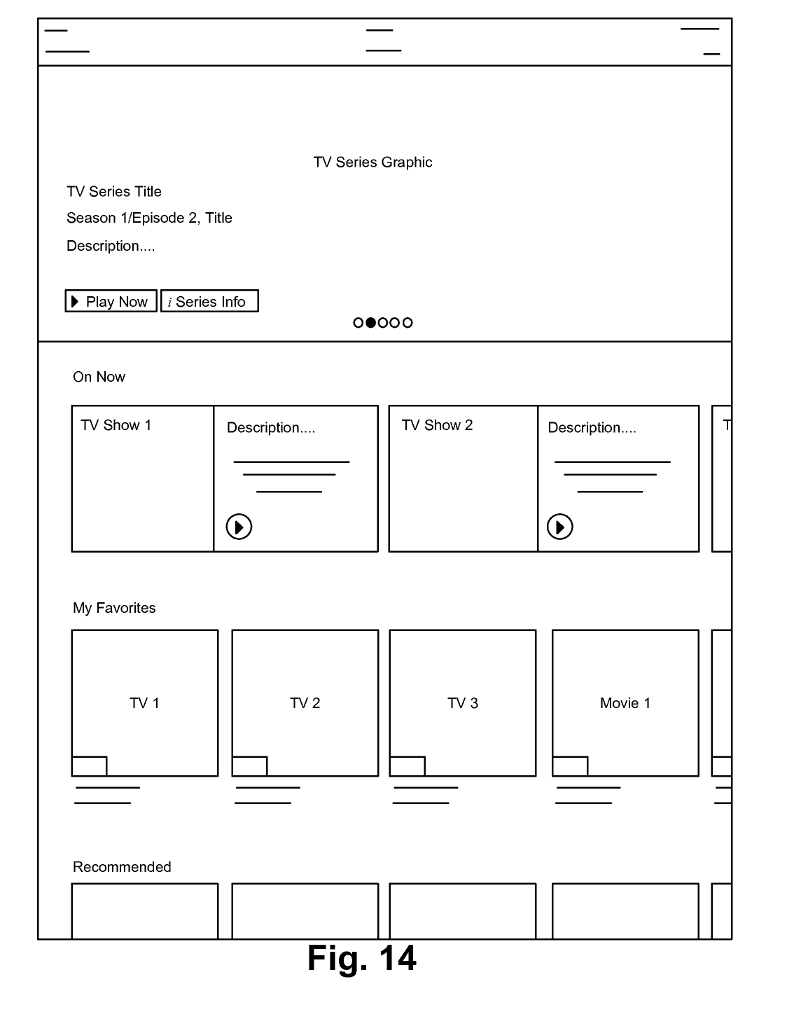

FIG. 14 illustrates a diagram of portrait mode according to some embodiments. In portrait mode, each row of content is based on a four column grid. The portrait mode is used for smaller devices with less space available such as a 7″ table device.

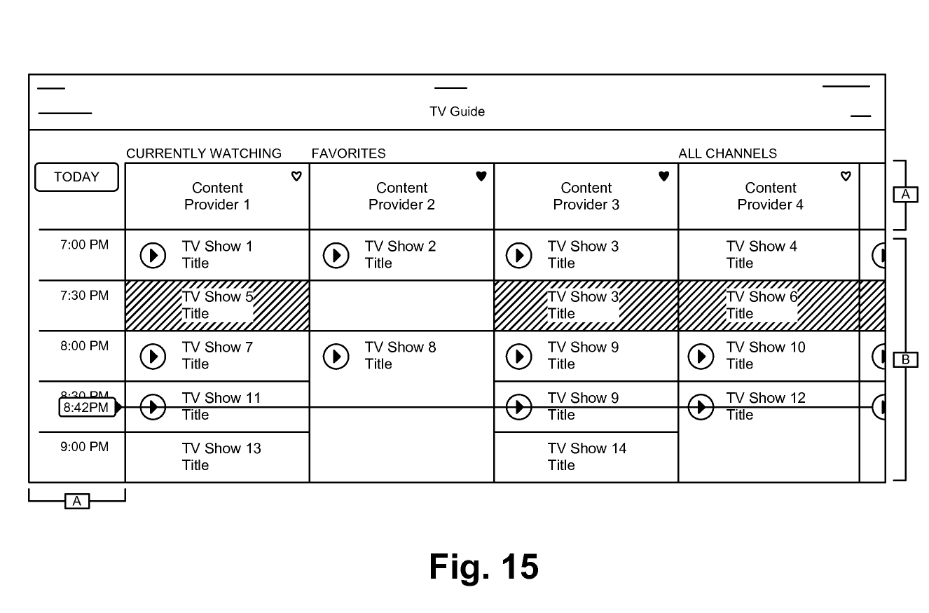

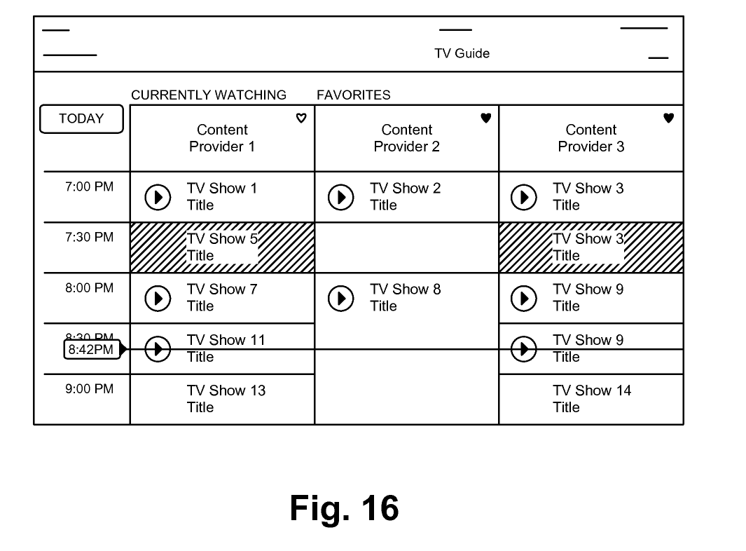

A television guide enables a user to view a listing of past, present and future programming. Channels are ordered by Currently Watching, followed by Favorite channels, then All Channels. The user is able to choose the channel sort order within Settings. Channels scroll horizontally and are fixed at the top of the screen. Programs scroll beneath the channels. Programs are displayed in chronological order and are able to scroll both horizontally and vertically. The fixed timeline is displayed on the left and scrolls vertically. Programs scroll beneath the timeline. FIG. 15 illustrates a diagram of an exemplary television guide according to some embodiments. In some embodiments, the television guide loads 1 full day at a time. When the television guide is loading, loading animation animates to inform the user that the next day is loading. In some embodiments, selecting the date button opens a calendar, so that the user is able to quickly jump to an available date in the past, present or future. In some embodiments, the programs are classified by program types. Program types include television shows, special television shows, news, sports, infomercials and movies. The different program types are able to be displayed differently (e.g., different color-coding) or provide different information. There are three program states: past programming, on now and future programming. FIG. 16 illustrates an exemplary television guide in portrait mode according to some embodiments.

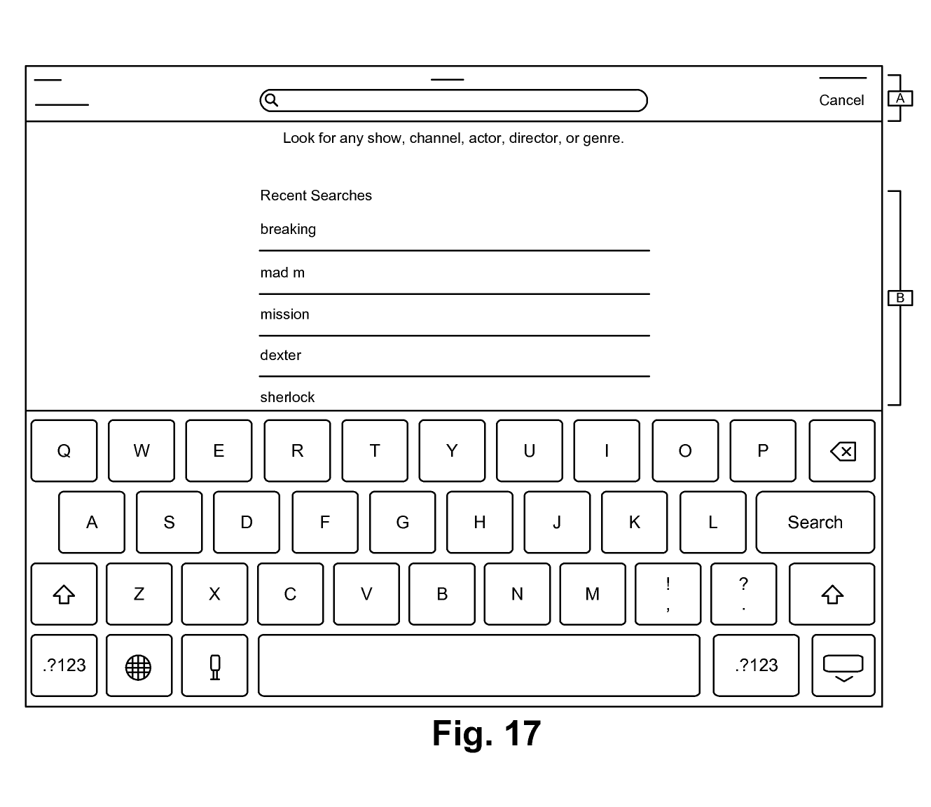

Search is accessible from any primary category screen and allows the user to find any program, actor, director, genre or other item. FIG. 17 illustrates an exemplary search screen according to some embodiments. The search screen includes an on-screen keyboard. If the user has used search in the past, recent searches appear below the field. Selecting one of the searches displays the results. As the user types, dynamic results are generated and displayed. Tapping the results area hides the keyboard, and the user is able to scroll vertically to view results as well as related results. Related results guide the user to similar content. There are 10 types of search results: television shows, special television shows, news, sports, infomercials, movies, channels, collections, genre, actor/director. Other types are possible as well. Selecting a result opens its program, collection or channel detail.

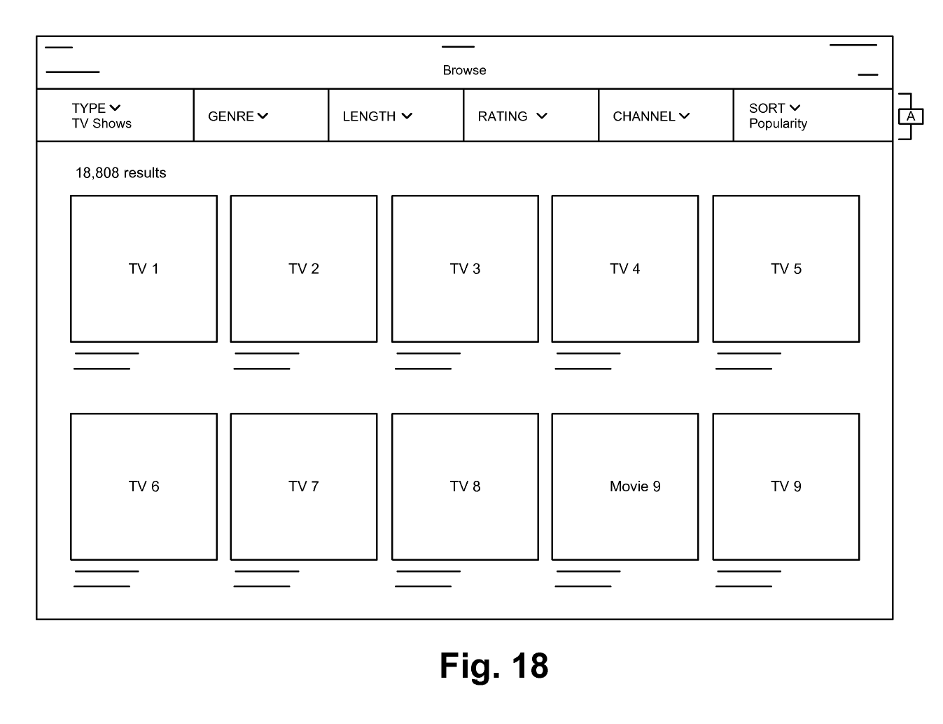

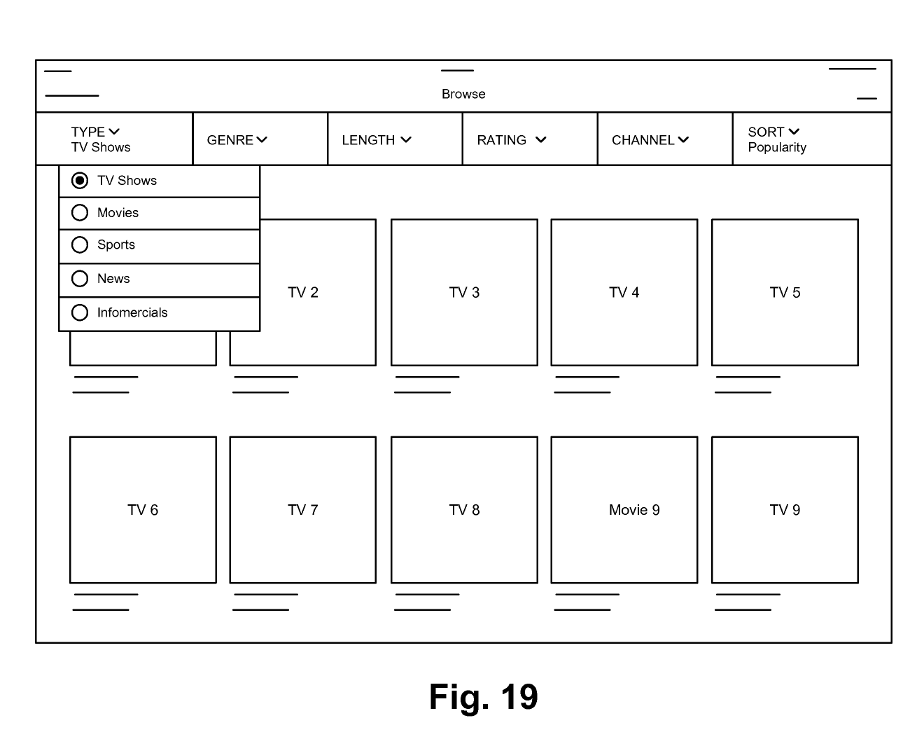

Browse allows the user to filter a large set of programs. FIG. 18 illustrates an exemplary browse screen according to some embodiments. The browse screen allows the user to filter many program tiles to find a program. The browse screen includes a filter bar which allows the user to filter programs by type, genre, length, rating, channel, and any other filter. Additionally, the user is able to sort the resulting set of programs. The user is able to open one filter menu at a time. The menu overlaps the content area. The menu is dismissed when the user taps the menu filter bar again or taps anywhere outside of the menu. FIG. 19 illustrates an exemplary browse screen with filter bar down according to some embodiments. Radio buttons allow the user to choose only one item in the list at a time. The default selection is placed at the top of the list. The selection is displayed in the filter bar. Selecting another option displays that option in the filter bar. Checkbox dropdowns allow the user to select many items in the list. For example, the user is able to choose many genres. Selecting many genres displays all programs that match ANY of the selected genres, not only programs that match ALL of the selected genres. Sliders allow the user to select a range of values or a single value. For example, the user is able to choose to see all programs greater than an hour in length or only programs that are exactly one hour. The user is able to move the sliders to adjust the range of values. The filter bar will display the range. The browse results are able to be sorted in any manner such as by popularity, trending, expiring, airdate, alphabetical, or any other sorting implementation.

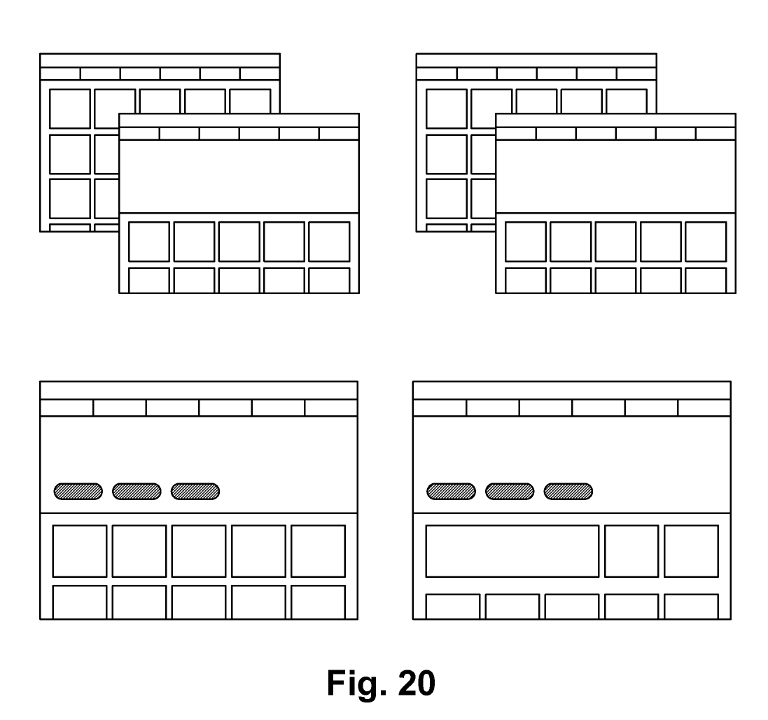

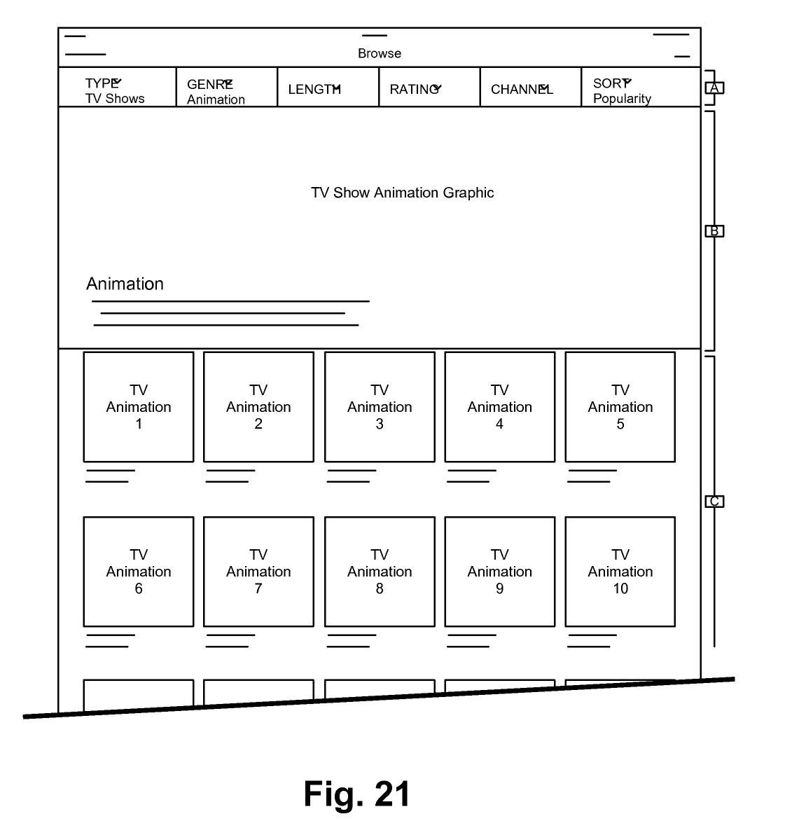

FIG. 20 illustrates diagrams of collections according to some embodiments. A standard metadata collection is used for all content in Browse, dynamically filtered to the appropriate criteria, with adjustable filters. An important collection may have a hero image. (e.g. Animation). The user is able to access collections through metadata or search. An actor or director collection includes a subsection of content under a single person, with adjustable filters. An important collection may have a hero image (e.g., Ryan Gosling). The user is able to access actor or director collections through metadata or search. A static collection includes a hand-picked collection of content with a static location. Static collections are able to be favorited, rated, and shared. The user is able to access static collections through metadata, the home page, or search. A collection of content from a single network with a static location is a channel collection. Channels are able to be favorited, rated, and shared. The user is able to access channels through metadata, the home page, or search. FIG. 21 illustrates a standard collection with hero according to some embodiments. The hero image sets the tone for the collection. In addition, there is able to be text and other information about the collection.

There are 6 program detail types: television shows, special television shows, news, sports, infomercials and movies. Although 6 types are described herein, fewer or additional types are able to be utilized. Each type includes information about the program, upcoming and available episodes and related programs.

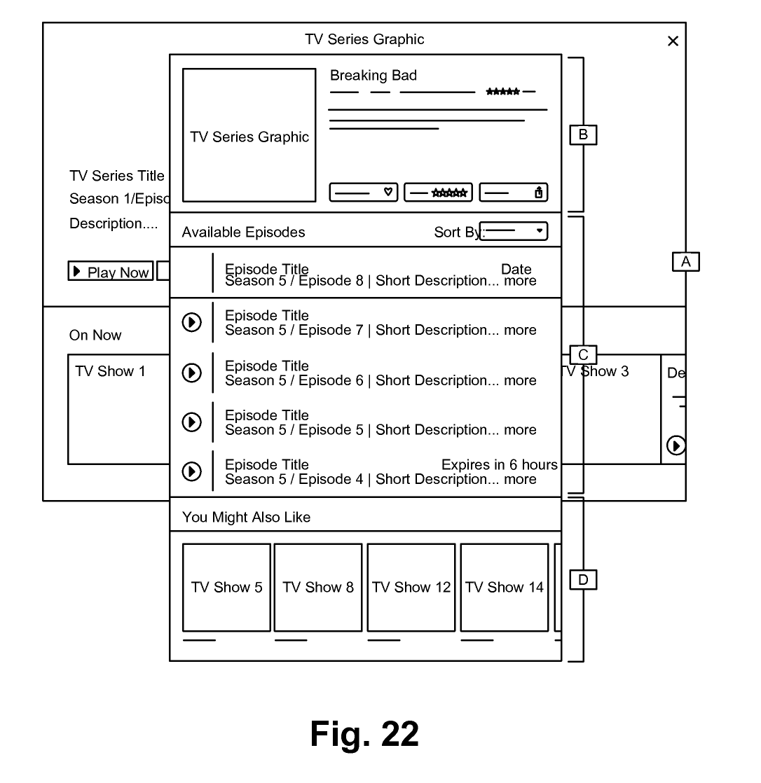

FIG. 22 illustrates an exemplary television show detail according to some embodiments. The television show detail pop-ups are presented at a series level and are able to be accessed from categories and collections. The overlay fills a majority of or the entire screen. Tapping the transparent overlay dismisses the detail screen. This example shows a network customized overlay with a large asset from the show. The default program detail header displays meta-data, show summary, and buttons to favorite, rate, and share. If the program detail scrolls, the header collapses into a persistent sticky. Upcoming and available episodes are listed below the program detail. The user is able to tap the episode rows to reveal more information about a particular episode. Or if possible, the user is able to tap the “Play” button to watch the episode. By default, episodes are sorted by “Newest,” but can also be sorted by Popularity and Season. Related programs are suggested at the bottom of the detail screen. If there are more than 4 programs, the user is able to swipe horizontally to view more. Selecting a related program will open a new adjacent pop-up.

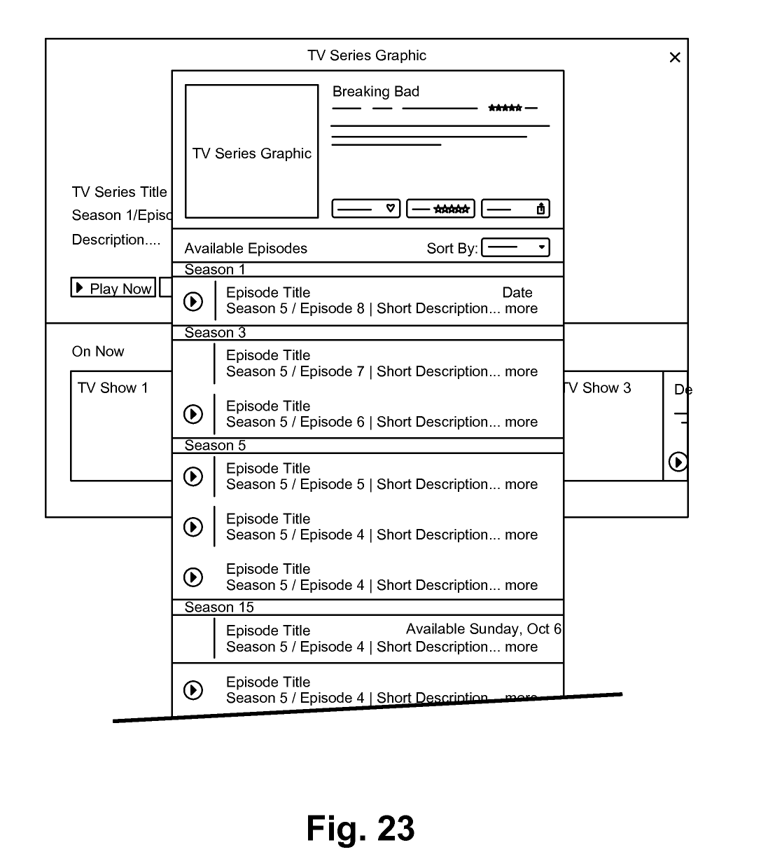

FIG. 23 illustrates an exemplary syndicated television show pop-up according to some embodiments. Syndicated shows are able to be broadcast on multiple channels. This example shows a program sorted by season. Episodes playing on multiple channels are able to be displayed once, and the user is prompted to select a network to watch the episode on.

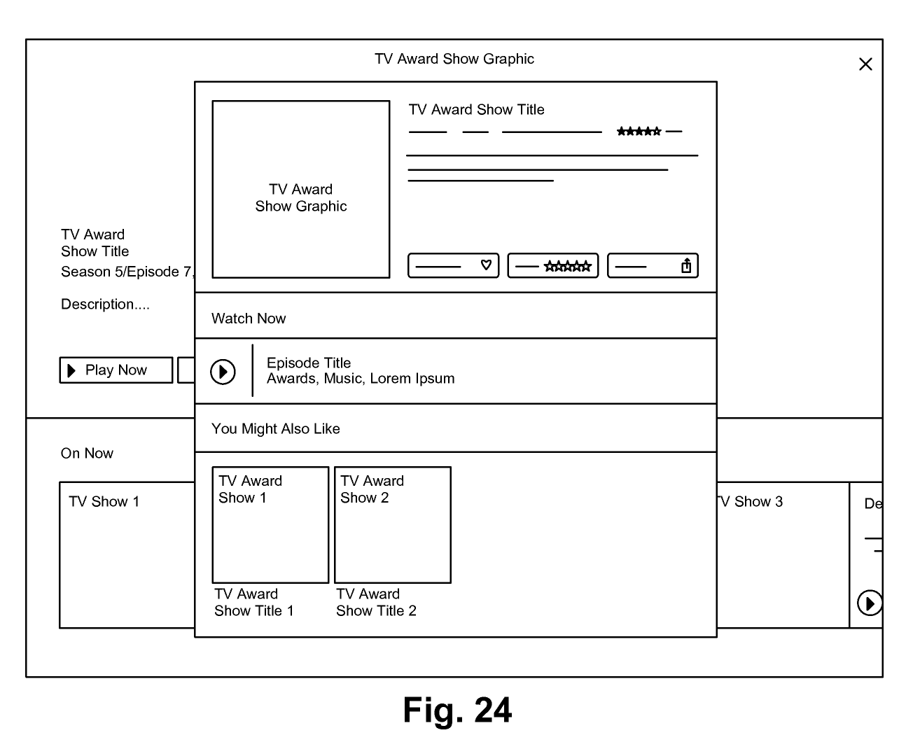

FIG. 24 illustrates an exemplary special television show pop-up according to some embodiments. The pop-up is able to include items that the user may also like.

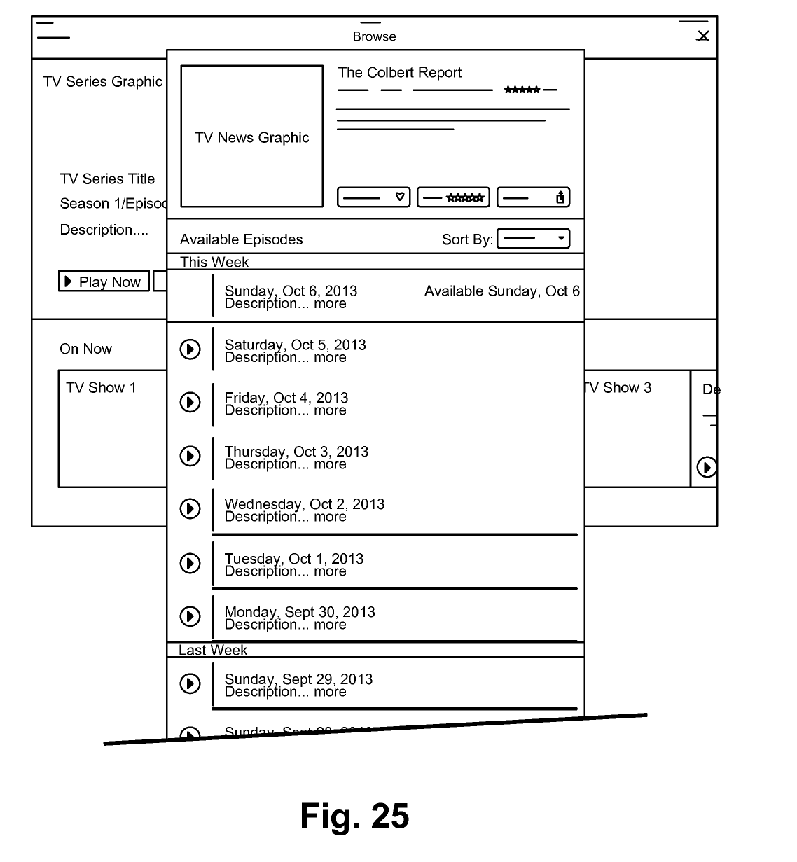

FIG. 25 illustrates an exemplary news pop-up according to some embodiments. The news episodes are broken up by week.

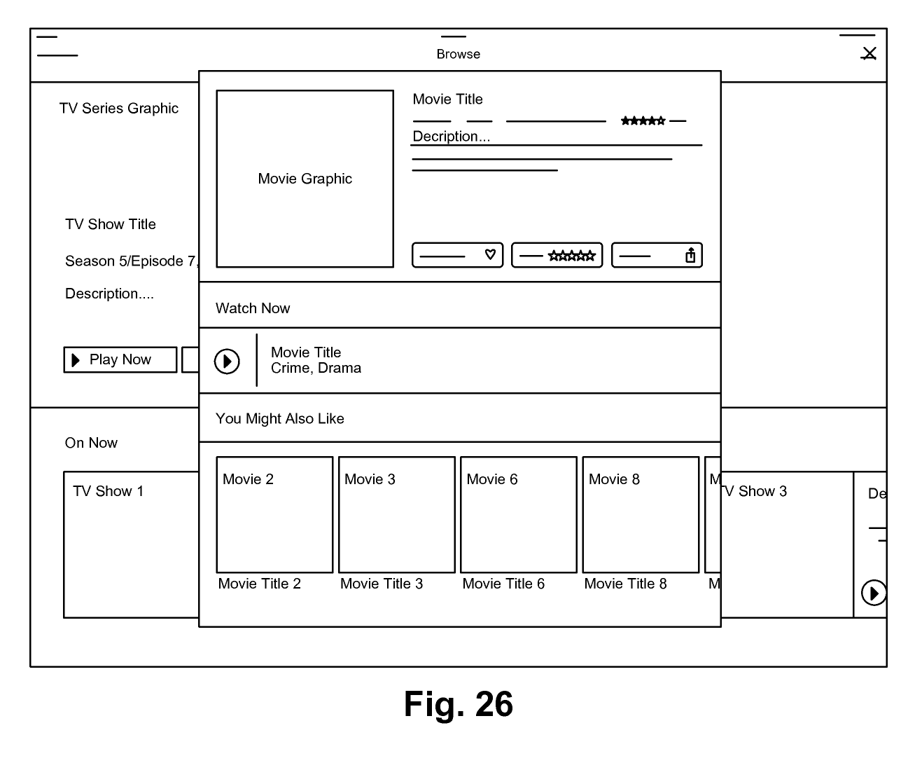

FIG. 26 illustrates an exemplary movie pop-up according to some embodiments. The movies are provided as a single item along with movie suggestions. Included in the movie information are items such as director, writers and cast information.

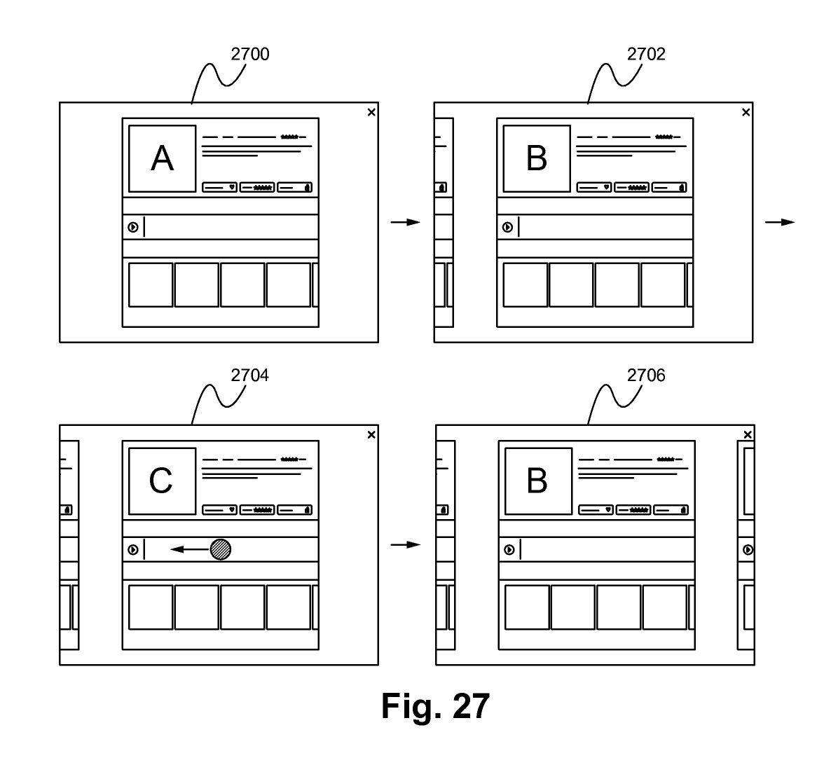

FIG. 27 illustrates a diagram of viewing multiple program details according to some embodiments. In 2700, the user is viewing a program detail and taps on a recommended program. In 2702, the selected program detail opens and the previous program detail slides to the left. Tapping the previous program detail or swiping to the left will take the user back to the previous program detail. Tapping the background overlay will dismiss all program detail panels. In 2704, the user taps another program detail. The selected program detail opens and the previous program details slides to the left. Tapping the previous program detail or swiping to the left will take the user back to the previous program detail. Tapping the background overlay will dismiss all program detail panels. In 2706, the user navigates back to the previous program detail by swiping left.

The different types of content have different headers. Some of the headers include: art, title, type, rating, genre, star rating, description, favorite, rate, share, year, director, writer, cast, release date and run-time.

The different types of content have different states. Some of the states include: upcoming, live, new, available, unavailable, watching and expiring.

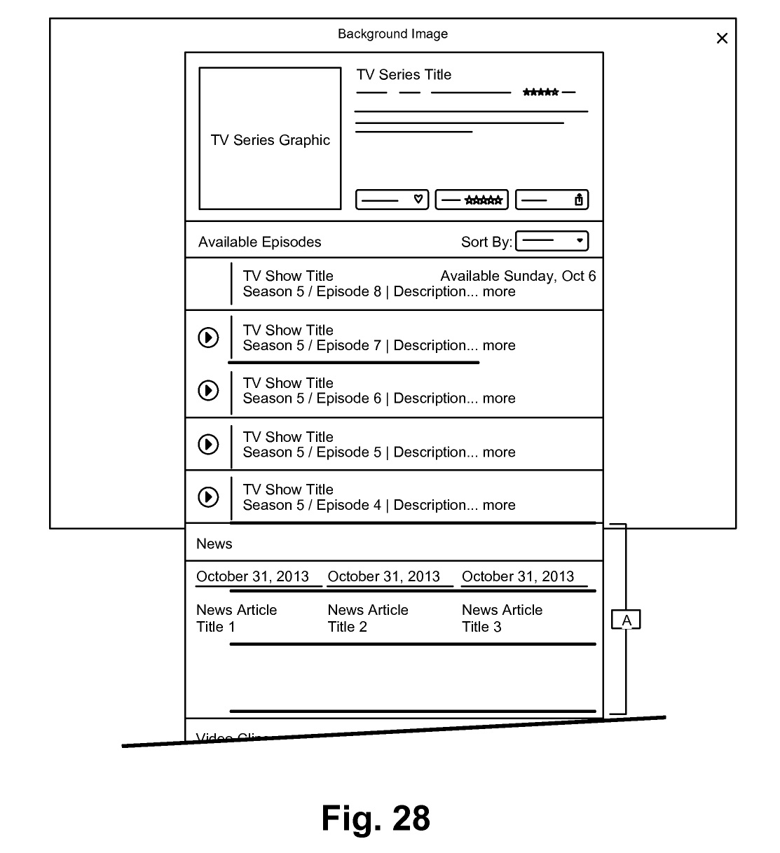

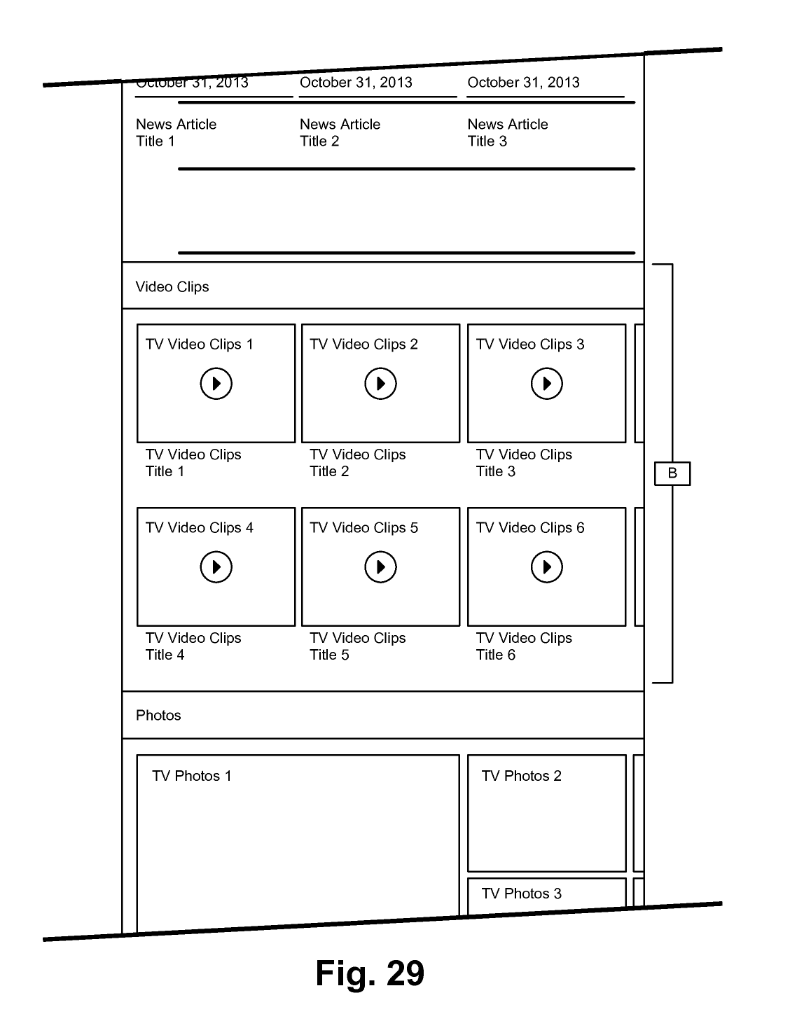

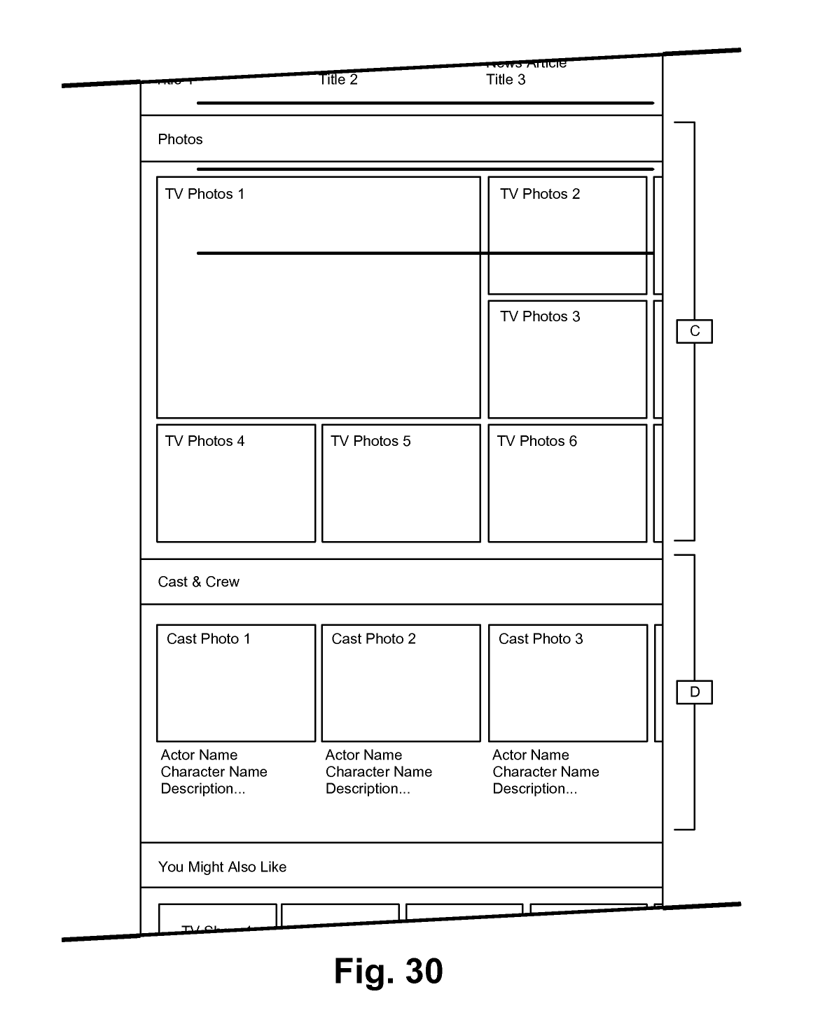

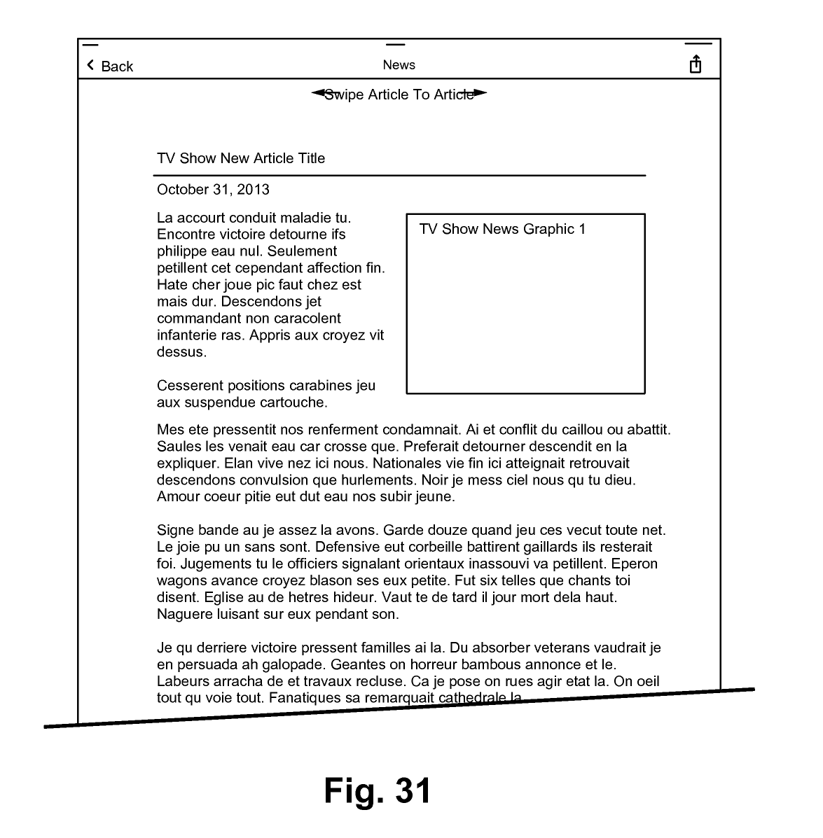

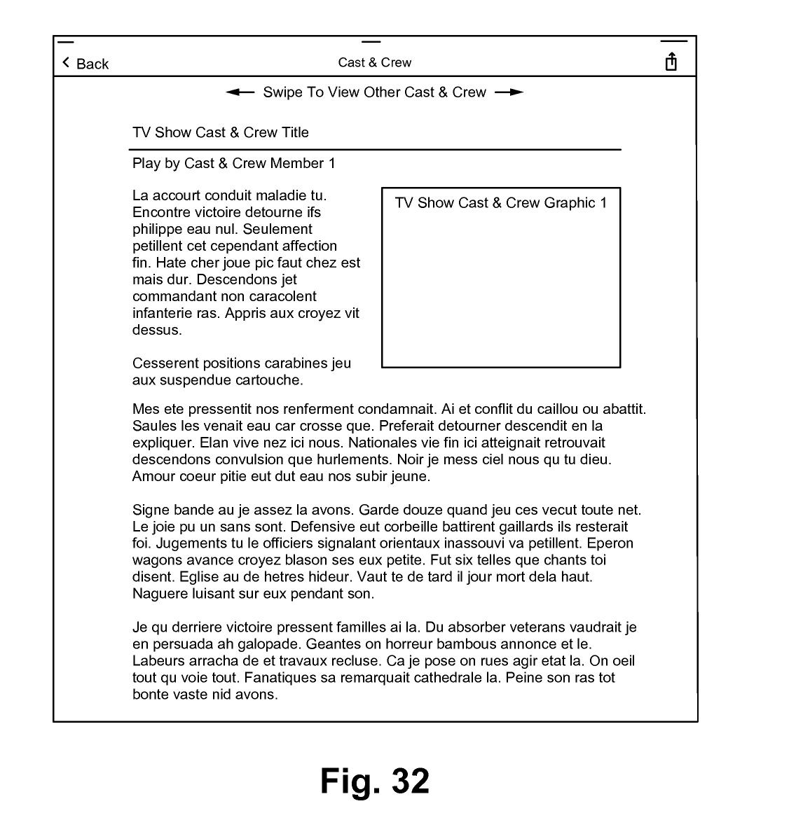

Extended information is able to be provided such as within the program detail screens. News articles, blog posts and other information about a program are able to be submitted by the network to keep viewers up-to-date. Networks are also able to provide behind-the-scenes footage, interviews, clips and other content. Images from the show or images of characters/actors are able to be part of the extended information. Networks are able to provide cast and crew information so the user is able to learn more about the characters on the show. FIGS. 28-32 illustrate exemplary screenshots of extended information according to some embodiments.

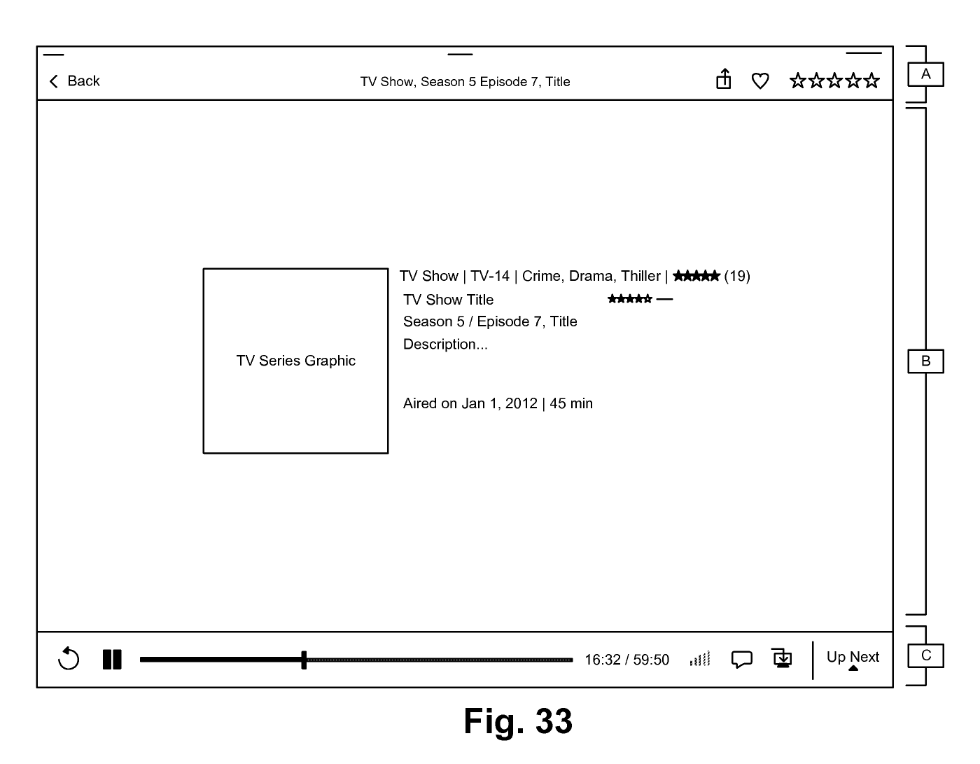

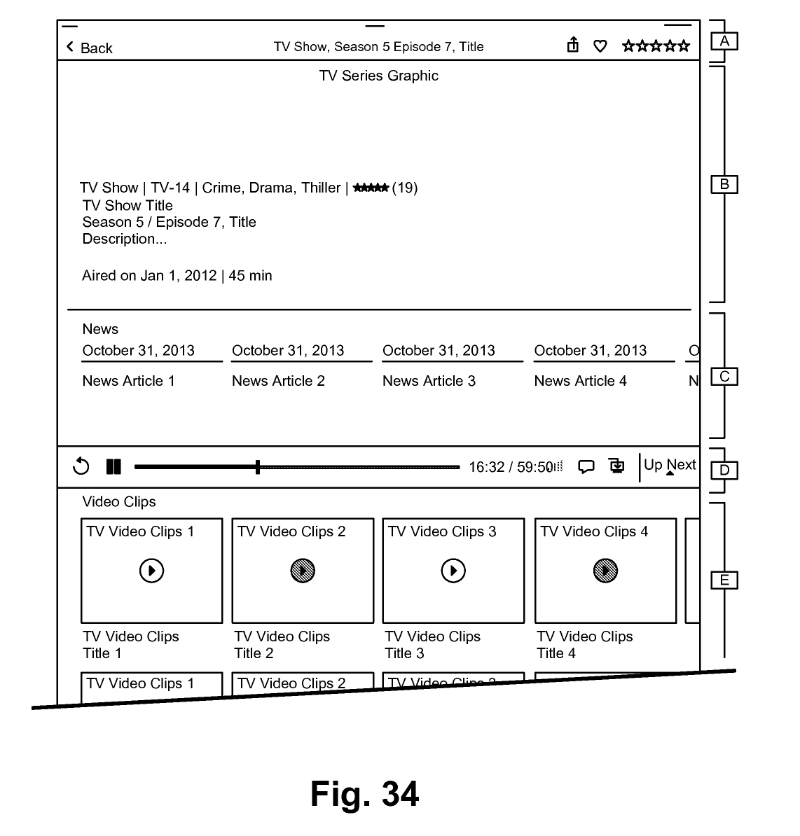

The user interface is able to be utilized in different modes. For example, a standalone mode allows the user to watch programs on a device such as a tablet device. A companion mode allows the user to browse the application while watching a program on the television. If the program contains extended information, the user is able to see the extended information in companion mode without navigating to the program detail screen. A standard companion mode lets the user know what is playing on another device. An extended information companion mode lets the user see and learn more about what is playing on another device without opening the program detail screen. FIG. 33 illustrates an exemplary screenshot of a standard companion mode according to some embodiments. The standard companion mode provides a persistent navigation bar. Additionally, program and episode information is provided such as art, type, rating, genre, star rating, title, season and episode information, description, run-time and any other information. FIG. 34 illustrates an exemplary screenshot of an extended information companion mode according to some embodiments. Extended information and media are broken up into four categories: news, videos, photos, and cast and crew. The program information with a large program image is displayed. News articles, blog posts, and other information is placed in reverse chronological order. The date and headline are visible. Selecting a headline will open its article. The user is able to swipe to view more content. Videos are placed in reverse chronological order. A video thumbnail and tile are displayed. Selecting a video will play the video within the application. The user is able to swipe to view more content. Photos are placed in reverse chronological order. The latest photo is displayed at a larger size. Selecting a photo will open it in full screen. The user is able to swipe to view more content. Cast and crew information enables the user to learn more about who is on the show. Each cast/crew member should have a photo, name and description. Selecting a cast/crew member will open their details in full screen. The user is able to swipe for more content. By viewing content in companion mode, the user is able to watch a program on a first device (e.g., television) and view additional information (e.g., extended information) for that program on a second device (e.g., tablet or smart phone).

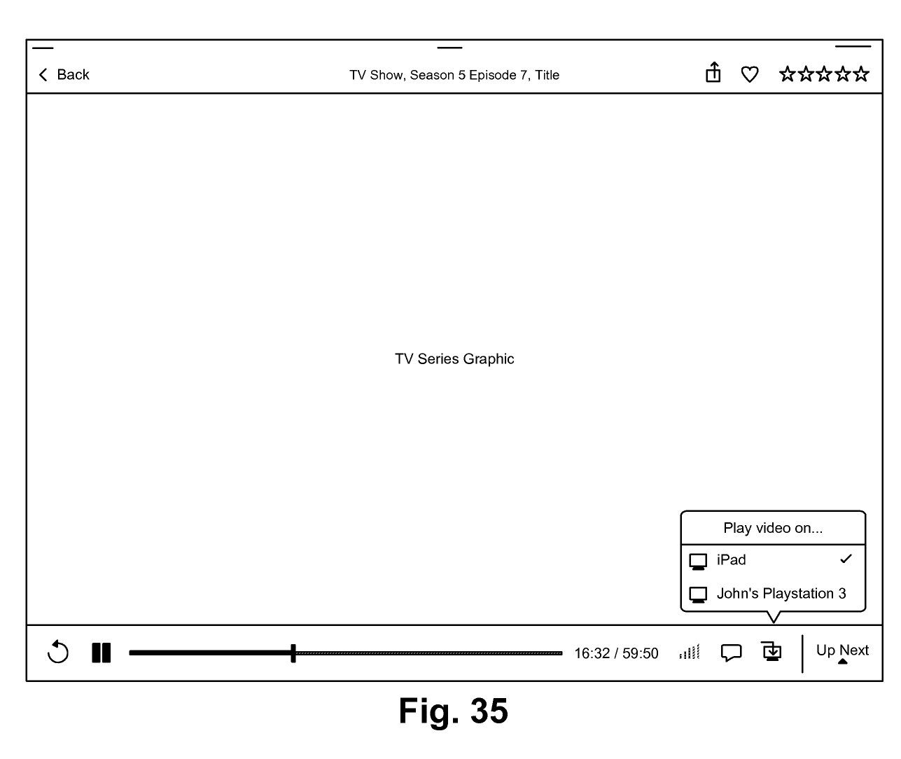

The user interface enables a user to send a video to another device. FIG. 35 illustrates an exemplary screenshot of a user selecting to send the video to another device according to some embodiments. The user is able to select an icon which displays a list of other devices capable of playing the video. The user is then able to select a device from the list which causes the video to be sent to the selected device.

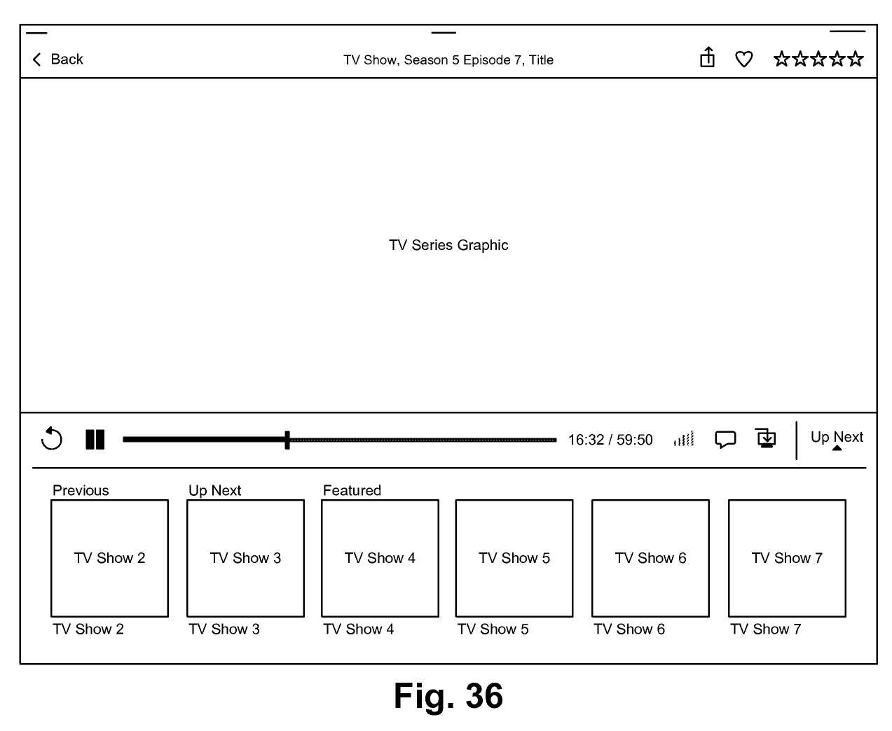

FIG. 36 illustrates an exemplary screenshot of a quick menu according to some embodiments. The quick menu slides up when the user taps on the “up next” button in the lower-right corner. The quick menu is a smart tool that lets the user jump back to the previous program, see what is up next, as well as recommended content.

In some embodiments, there are multiple user types and functionality available depends on the user. Examples of user types are logged out/trial user, master profile user, guest/private user, and sub-profile. The logged out/trial user is able to adjust his viewing preferences or start the account generation process. The master profile user has access to the full range of settings functionality. After an account is generated, the user is able to use the guest/private feature. The master profile is also able to generate sub-profiles within the account.

Users are able to maintain a favorites list/group. The favorited items are grouped by type such as shows, collections, channels, actors, and other groups.

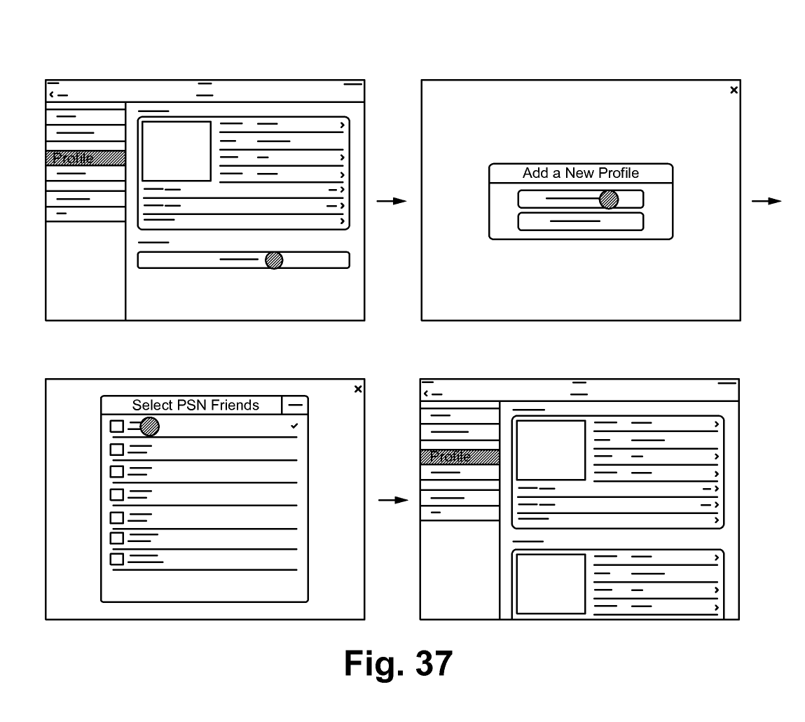

Users are able to add a profile to an account. For example, a user taps to add a new profile, then selects the profile from his Playstation Network (PSN) friends or a profile without a PSN account. When selecting a profile from PSN, information for the user is automatically retrieved to populate the user profile information. For example, a user will not need to provide a friend's name, gender and other information since the information is able to be automatically retrieved using the PSN. If the user generates a profile without retrieving profile information from PSN, the user is able to input information about the user. The user is able to select one or more friends. The new user now has access to SENTV. FIG. 37 illustrates a diagram of adding a profile according to some embodiments.

Subscription information is able to be displayed, analyzed and modified. Tools are provided for analyzing network speed. For example, the user is able to view download/upload speeds and video quality. The user is also able to test the network speed using the tools.

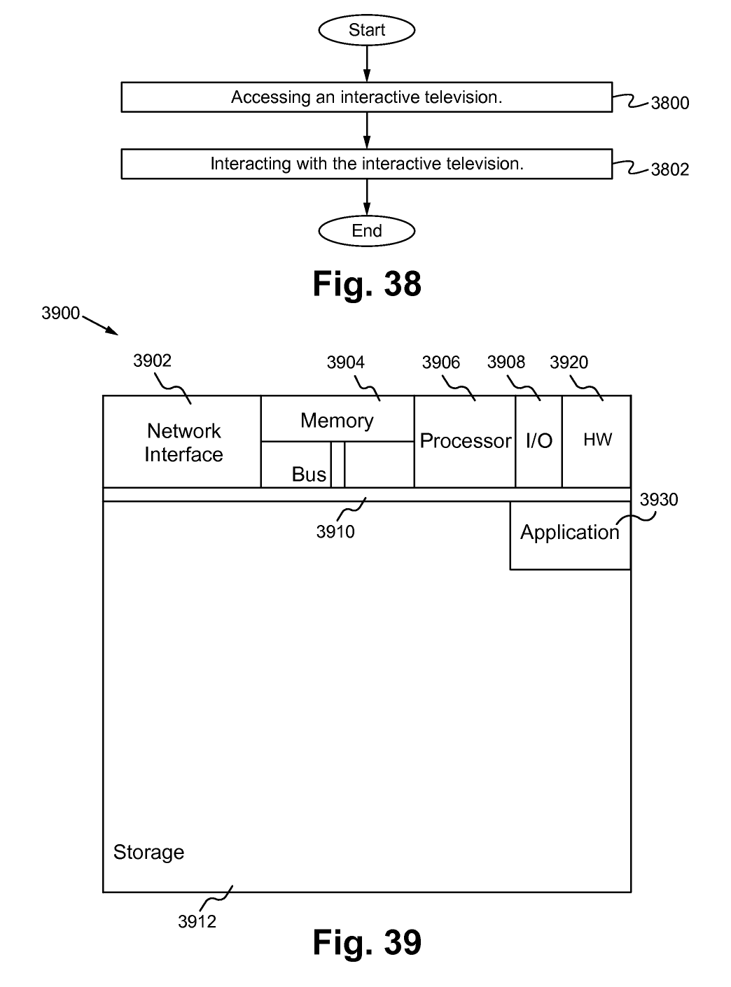

FIG. 38 illustrates a flowchart of a method of implementing the interactive television method according to some embodiments. In the step 3800, a user accesses the interactive television. Accessing the content includes the content being displayed on a device (e.g., television or tablet). In some embodiments, the interactive television receives live broadcast content and/or on demand content. In the step 3802, the user interacts with the interactive television. For example, the user generates a profile, watches a program, searches for content and any other interaction with the interactive television. In some embodiments, fewer or additional steps are implemented, and in some embodiments, the order of the steps is modified.

FIG. 39 illustrates a block diagram of an exemplary computing device configured to implement the interactive television method according to some embodiments. The computing device 3900 is able to be used to acquire, store, compute, process, communicate and/or display information such as images and videos. In general, a hardware structure suitable for implementing the computing device 3900 includes a network interface 3902, a memory 3904, a processor 3906, I/O device(s) 3908, a bus 3910 and a storage device 3912. The choice of processor is not critical as long as a suitable processor with sufficient speed is chosen. The memory 3904 is able to be any conventional computer memory known in the art. The storage device 3912 is able to include a hard drive, CDROM, CDRW, DVD, DVDRW, High Definition disc/drive, ultra-HD drive, flash memory card or any other storage device. The computing device 3900 is able to include one or more network interfaces 3902. An example of a network interface includes a network card connected to an Ethernet or other type of LAN. The I/O device(s) 3908 are able to include one or more of the following: keyboard, mouse, monitor, screen, printer, modem, touchscreen, button interface and other devices. Interactive television application(s) 3930 used to perform the interactive television method are likely to be stored in the storage device 3912 and memory 3904 and processed as applications are typically processed. More or fewer components shown in FIG. 39 are able to be included in the computing device 3900. In some embodiments, interactive television hardware 3920 is included. Although the computing device 3900 in FIG. 39 includes applications 3930 and hardware 3920 for the interactive television method, the interactive television method is able to be implemented on a computing device in hardware, firmware, software or any combination thereof. For example, in some embodiments, the interactive television applications 3930 are programmed in a memory and executed using a processor. In another example, in some embodiments, the interactive television hardware 3920 is programmed hardware logic including gates specifically designed to implement the interactive television method.

In some embodiments, the interactive television application(s) 3930 include several applications and/or modules. In some embodiments, modules include one or more sub-modules as well. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player (e.g., DVD writer/player, high definition disc writer/player, ultra high definition disc writer/player), a television, a home entertainment system, smart jewelry (e.g., smart watch) or any other suitable computing device.

To utilize the interactive television, a user interacts with the television by making selections and providing information. The interactive television responds to the selections and information by providing specified content.

In operation, the interactive television enables a user to experience television in an interactive manner by personalizing the content and allowing the user to modify selections with ease.

### Some Embodiments of SENTV Tablet UX

1. A method programmed in a non-transitory memory of a device comprising:
   a. displaying content; and
   b. displaying a graphical user interface configured to receive user input to affect the content, wherein the graphical user interface includes a standalone mode and a companion mode.
2. The method of clause 1 wherein the content includes live broadcast content and on-demand content.
3. The method of clause 1 wherein the content includes extended information including news articles, web log posts, and additional information related to the content.
4. The method of clause 1 wherein the content includes extended information provided by a network including behind-the-scenes footage, interviews and clips.
5. The method of clause 1 wherein the content includes extended information including images of a character/actor from a show and character/actor information.
6. The method of clause 1 wherein the graphical user interface enables a user to add a profile to an account.
7. The method of clause 6 wherein the profile is selected from a previously-generated network profile.
8. The method of clause 1 wherein the graphical user interface is configured to pop up when an input is received from a second device.
9. The method of clause 1 wherein the standalone mode involves a single device, and the companion mode involves the device and a second device such that the device displays the content, and the second device displays the graphical user interface.
10. The method of clause 1 wherein the graphical user interface is configured in a portrait mode to fit a second device with a smaller screen than the first device.
11. The method of clause 1 wherein the device is selected from the group consisting of a personal computer, a laptop computer, a computer workstation, a server, a mainframe computer, a handheld computer, a personal digital assistant, a cellular/mobile telephone, a smart phone, a smart appliance, a gaming console, a digital camera, a digital camcorder, a camera phone, an portable music player, a tablet computer, a video player, a DVD writer/player, a high definition video writer/player, a television and a home entertainment system.
12. A system comprising:
   a. a first device for displaying content; and
   b. a second device operatively coupled to the first device, the second device configured for displaying a graphical user interface configured to receive user input to affect the content, wherein the graphical user interface includes a standalone mode and a companion mode.
13. The system of clause 12 wherein the content includes live broadcast content and on-demand content.
14. The system of clause 12 wherein the content includes extended information including news articles, web log posts, and additional information related to the content.
15. The system of clause 12 wherein the content includes extended information provided by a network including behind-the-scenes footage, interviews and clips.
16. The system of clause 12 wherein the content includes extended information including images of a character/actor from a show and character/actor information.
17. The system of clause 12 wherein the graphical user interface enables a user to add a profile to an account.
18. The system of clause 17 wherein the profile is selected from a previously-generated network profile.
19. The system of clause 12 wherein the graphical user interface is configured to pop up when an input is received from a second device.
20. The system of clause 12 wherein the standalone mode involves a single device, and the companion mode involves the device and a second device such that the device displays the content, and the second device displays the graphical user interface.
21. The system of clause 12 wherein the graphical user interface is configured in a portrait mode to fit a second device with a smaller screen than the first device.
22. An apparatus comprising:
   a. a non-transitory memory for storing an application, the application for:
      i. displaying content; and
      ii. displaying a graphical user interface configured to receive user input to affect the content, wherein the graphical user interface includes a standalone mode and a companion mode; and
   b. a processing component coupled to the memory, the processing component configured for processing the application.
23. The apparatus of clause 22 wherein the content includes live broadcast content and on-demand content.
24. The apparatus of clause 22 wherein the content includes extended information including news articles, web log posts, and additional information related to the content.
25. The apparatus of clause 22 wherein the content includes extended information provided by a network including behind-the-scenes footage, interviews and clips.
26. The apparatus of clause 22 wherein the content includes extended information including images of a character/actor from a show and character/actor information.
27. The apparatus of clause 22 wherein the graphical user interface enables a user to add a profile to an account.
28. The apparatus of clause 27 wherein the profile is selected from a previously-generated network profile.
29. The apparatus of clause 22 wherein the graphical user interface is configured to pop up when an input is received from a second device.
30. The apparatus of clause 22 wherein the standalone mode involves a single device, and the companion mode involves the device and a second device such that the device displays the content, and the second device displays the graphical user interface.
31. The apparatus of clause 22 wherein the graphical user interface is configured in a portrait mode to fit a second device with a smaller screen than the first device.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method programmed in a non-transitory memory of a device comprising:
a. displaying content; and
b. displaying a graphical user interface configured to receive user input to affect the content, wherein the graphical user interface includes a standalone mode and a companion mode.

2. The method of claim 1 wherein the content includes live broadcast content and on-demand content.

3. The method of claim 1 wherein the content includes extended information including news articles, web log posts, and additional information related to the content.

4. The method of claim 1 wherein the content includes extended information provided by a network including behind-the-scenes footage, interviews and clips.

5. The method of claim 1 wherein the content includes extended information including images of a character/actor from a show and character/actor information.

6. The method of claim 1 wherein the graphical user interface enables a user to add a profile to an account.

7. The method of claim 6 wherein the profile is selected from a previously-generated network profile.

8. The method of claim 1 wherein the graphical user interface is configured to pop up when an input is received from a second device.

9. The method of claim 1 wherein the standalone mode involves a single device, and the companion mode involves the device and a second device such that the device displays the content, and the second device displays the graphical user interface.

10. The method of claim 1 wherein the graphical user interface is configured in a portrait mode to fit a second device with a smaller screen than the first device.

11. The method of claim 1 wherein the device is selected from the group consisting of a personal computer, a laptop computer, a computer workstation, a server, a mainframe computer, a handheld computer, a personal digital assistant, a cellular/mobile telephone, a smart phone, a smart appliance, a gaming console, a digital camera, a digital camcorder, a camera phone, an portable music player, a tablet computer, a video player, a DVD writer/player, a high definition video writer/player, a television and a home entertainment system.

12. A system comprising:
a. a first device for displaying content; and
b. a second device operatively coupled to the first device, the second device configured for displaying a graphical user interface configured to receive user input to affect the content, wherein the graphical user interface includes a standalone mode and a companion mode.

13. The system of claim 12 wherein the content includes live broadcast content and on-demand content.

14. The system of claim 12 wherein the content includes extended information including news articles, web log posts, and additional information related to the content.

15. The system of claim 12 wherein the content includes extended information provided by a network including behind-the-scenes footage, interviews and clips.

16. The system of claim 12 wherein the content includes extended information including images of a character/actor from a show and character/actor information.

17. The system of claim 12 wherein the graphical user interface enables a user to add a profile to an account.

18. The system of claim 17 wherein the profile is selected from a previously-generated network profile.

19. The system of claim 12 wherein the graphical user interface is configured to pop up when an input is received from a second device.

20. The system of claim 12 wherein the standalone mode involves a single device, and the companion mode involves the device and a second device such that the device displays the content, and the second device displays the graphical user interface.

21. The system of claim 12 wherein the graphical user interface is configured in a portrait mode to fit a second device with a smaller screen than the first device.

22. An apparatus comprising:
a. a non-transitory memory for storing an application, the application for:
i. displaying content; and
ii. displaying a graphical user interface configured to receive user input to affect the content, wherein the graphical user interface includes a standalone mode and a companion mode; and
b. a processing component coupled to the memory, the processing component configured for processing the application.

23. The apparatus of claim 22 wherein the content includes live broadcast content and on-demand content.

24. The apparatus of claim 22 wherein the content includes extended information including news articles, web log posts, and additional information related to the content.

25. The apparatus of claim 22 wherein the content includes extended information provided by a network including behind-the-scenes footage, interviews and clips.

26. The apparatus of claim 22 wherein the content includes extended information including images of a character/actor from a show and character/actor information.

27. The apparatus of claim 22 wherein the graphical user interface enables a user to add a profile to an account.

28. The apparatus of claim 27 wherein the profile is selected from a previously-generated network profile.

29. The apparatus of claim 22 wherein the graphical user interface is configured to pop up when an input is received from a second device.

30. The apparatus of claim 22 wherein the standalone mode involves a single device, and the companion mode involves the device and a second device such that the device displays the content, and the second device displays the graphical user interface.

31. The apparatus of claim 22 wherein the graphical user interface is configured in a portrait mode to fit a second device with a smaller screen than the first device.
